(19) United States
(12) Patent Application Publication
(10) Pub. No.: US 2026/0288775 A1
(43) Pub. Date: Sep. 24, 2026

(54) SYSTEM

(71) Applicant: SoftBank Group Corp., Tokyo (JP)

(72) Inventor: Yuki OTA, Tokyo (JP)

(73) Assignee: SoftBank Group Corp., Tokyo (JP)

(21) Appl. No.: 19/567,037

(22) Filed: Mar. 14, 2026

(30) Foreign Application Priority Data
Mar. 19, 2025 (JP) 2025-045159

(51) Int. Cl. G06F 16/332

(52) U.S. Cl. CPC G06F 16/3326

(57) ABSTRACT

A system includes a processor that is configured to generate a prompt for instructing a search of information based on content of a project, generate a prompt, using a generative artificial intelligence model, for analyzing the content of the project and for identifying a similar or related project, and generate a prompt for analyzing a sentiment of a user and for adjusting a priority of information provision based on the sentiment of the user.

### CROSS-REFERENCE TO RELATED APPLICATION

This application is based on and claims priority under 35 USC 119 from Japanese Patent Application No. 2025-045159 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional project support systems require users to manually search for information, identify similar or related past projects, and find relevant documents and human resources based on project content. In such systems, a user is typically required to formulate search queries, browse large volumes of search results, and subjectively determine which information is important. As a result, it is difficult to efficiently obtain highly relevant information, particularly when the project content is complex or spans multiple technical domains. In addition, conventional systems do not appropriately take into account the user's emotional state, such as stress, anxiety, or urgency, when presenting information. Therefore, there is a risk that information is presented with an unsuitable priority or in a manner that increases the cognitive load on the user. Furthermore, known systems lack a mechanism that systematically utilizes generative artificial intelligence models to analyze project content and automatically generate prompts for retrieving information and for recommending members with suitable skills. Accordingly, there is a need for a system that automatically generates prompts based on project content, analyzes the content by using a generative artificial intelligence model to identify similar or related projects, adjusts the priority of information provision based on user sentiment, and efficiently retrieves and presents related information and suitable members.

### SUMMARY

In order to solve the above-described problems, according to one aspect of the present invention, there is provided a system comprising a processor, wherein the processor is configured to generate a prompt for instructing a search of information based on content of a project, generate a prompt, using a generative artificial intelligence model, for analyzing the content of the project and for identifying a similar or related project, and generate a prompt for analyzing a sentiment of a user and for adjusting a priority of information provision based on the sentiment of the user. The processor is further configured to search a database using a generated prompt and acquire related information. Moreover, the processor is configured to generate a prompt for comparing the content of the project with a skill set of a member who has a skill required for the project, and perform a recommendation of the member. By automatically generating prompts for project analysis, database search, sentiment analysis, and member recommendation, and by utilizing a generative artificial intelligence model to interpret project content, the system can efficiently identify and retrieve similar or related projects, related information, and suitable members while dynamically adjusting the priority of information provision in accordance with the user's emotional state.

The term “system” refers to a combination of hardware and software components, including at least one processor and associated memory and interfaces, that cooperatively execute predefined processing for project support.

The term “processor” refers to one or more hardware processing units, such as a central processing unit (CPU), a graphics processing unit (GPU), or a specialized accelerator, that execute instructions to perform the functions described in the present specification.

The term “prompt” refers to a data structure or message, including natural language text or structured input, that is generated for the purpose of instructing an artificial intelligence model or another processing component to execute a specified operation.

The term “project” refers to a planned or ongoing activity or initiative, including its objectives, scope, tasks, technical content, and related contextual information, that is managed or supported by the system.

The term “content of a project” refers to textual or structured information that describes a project, including at least one of a project title, a project description, requirements, specifications, tasks, schedules, or tags.

The term “information” refers to data items, records, documents, or other digital resources stored in one or more databases or storage systems, which are relevant to a project, a user, or a member.

The term “search of information” refers to a process in which the system queries one or more databases or storage systems using a prompt or derived query conditions, and retrieves information that satisfies specified criteria.

The term “generative artificial intelligence model” refers to a machine-learned model, such as a large language model or another generative model, that generates outputs including text, prompts, or analysis results based on input data.

The term “analyzing the content of the project” refers to processing, by the generative artificial intelligence model or by the processor using a prompt, in which the semantic meaning, topics, requirements, or structure of the project content are extracted or interpreted.

The term “similar or related project” refers to a project that shares one or more characteristics with a target project, including at least similarity in technical field, objectives, requirements, methods, or resources, as determined by analysis of project content.

The term “user” refers to a person who operates a client device or terminal to input project content, receive search results, and interact with the system.

The term “sentiment of a user” refers to an emotional or psychological state of the user, including at least one of stress, anxiety, urgency, satisfaction, or interest, as inferred from user inputs, behaviors, or other signals.

The term “analyzing a sentiment of a user” refers to a process in which the system estimates or classifies the user's sentiment from input text, interaction logs, physiological signals, or other data.

The term “priority of information provision” refers to an order, ranking, or weighting used by the system to determine which information is presented first, emphasized, or highlighted to the user.

The term “adjusting a priority of information provision” refers to changing an order, ranking, or weighting of information to be presented, based at least in part on an estimated sentiment of the user.

The term “database” refers to any structured or unstructured data storage system, including relational databases, document stores, knowledge bases, or file repositories, that store projects, documents, member information, or other related data.

The term “related information” refers to information retrieved from a database that is determined to have relevance to the content of a project, a user's query, or a member recommendation.

The term “member” refers to a person belonging to an organization, team, or community, whose skills, experience, or role information is stored in association with the system.

The term “skill” refers to a technical, domain-specific, or functional capability possessed by a member, such as knowledge in artificial intelligence, programming languages, design, or project management.

The term “skill set of a member” refers to a collection of skills registered or associated with an individual member, which can be compared with project requirements.

The term “skill required for the project” refers to a capability or expertise that is determined, based on the content of the project, to be necessary or useful for executing or supporting the project.

The term “comparing the content of the project with a skill set of a member” refers to processing in which the system evaluates a degree of match or similarity between required skills inferred from the project content and skills recorded for a member.

The term “recommendation of the member” refers to an operation in which the system selects and outputs one or more members, in ranked or unranked form, as suitable candidates for participation in or support of the project.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

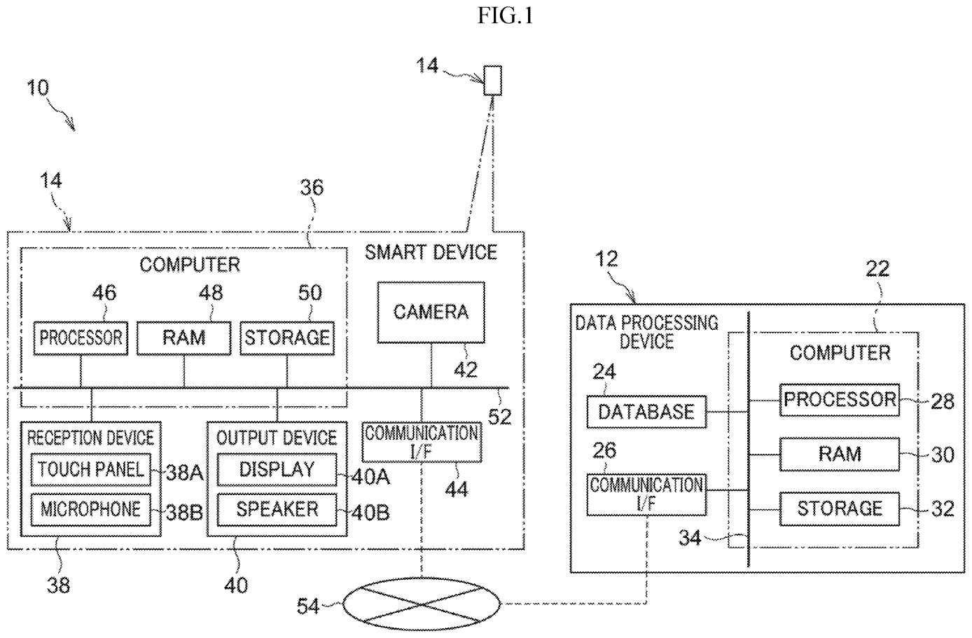

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

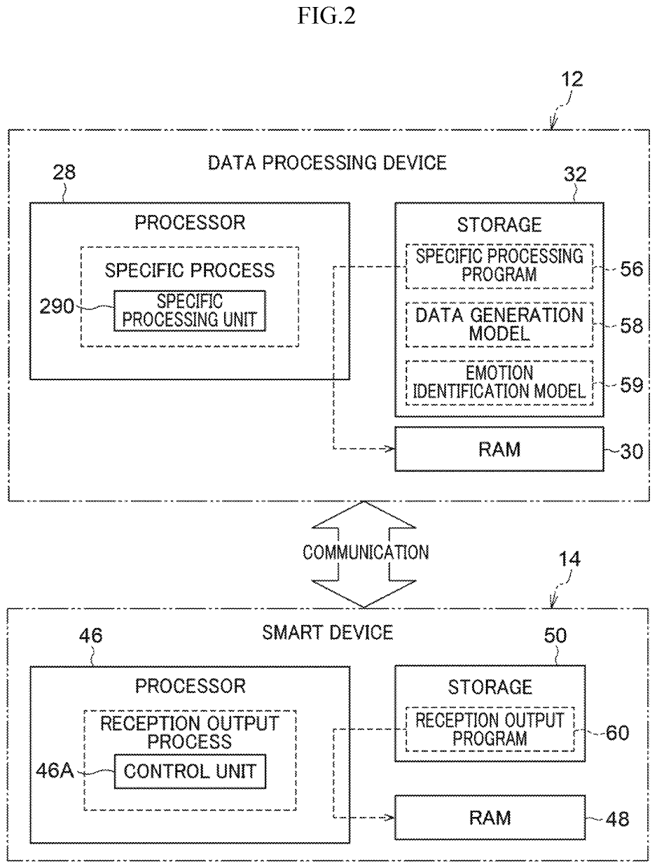

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In complex project environments, users are required to identify and utilize relevant digital resources, such as past project records, technical documents, and human resources, in a timely and accurate manner. Conventional information retrieval systems typically rely on keyword-based search or simple rule-based matching, which suffer from several technical limitations.

First, conventional systems do not efficiently exploit the semantic content of project descriptions provided as natural language text. Text is often processed with limited or no morphological analysis, syntactic analysis, or entity extraction, resulting in suboptimal feature representations for downstream similarity search. This leads to low recall and precision when retrieving past projects or related documents, and increases the computational burden of manual post-filtering by users.

Second, conventional architectures do not integrate heterogeneous search modalities—such as word-based search using inverted indexes and vector-based search using dense embeddings—into a unified, ranked result set in a systematic manner. As a consequence, separate search pipelines must be maintained and queried independently, which increases processing overhead, network load, and latency, while still providing fragmented results that the user needs to consolidate manually.

Third, existing systems often treat project resource recommendation and member recommendation as distinct functions, based on static rules or simple metadata matching. They do not compute and leverage a unified representation of project semantics and inferred required skills, and do not systematically compare such representations against structured and unstructured member profile data, including past project participation histories. This limits the accuracy and scalability of member recommendations and increases the computational cost of repeated or ad hoc matching.

Fourth, although generative AI models can generate summaries and recommendations, conventional systems typically invoke such models in an ad hoc manner, without a structured prompt-generation layer that encodes concrete retrieval and recommendation instructions. This leads to inconsistent outputs, unpredictable computational load, and difficulty in controlling how retrieved data is transformed and presented. Furthermore, user emotion or urgency is rarely modeled as a first-class signal in the retrieval pipeline, so presentation order and explanation level are not adaptively optimized, which can degrade user interaction efficiency and increase overall system workload due to repeated queries.

Accordingly, there is a need for an improved computer-implemented technique that: (i) transforms natural language project descriptions into richer, machine-usable representations by combining advanced preprocessing and semantic feature extraction; (ii) coordinates keyword-based search and vector-based search within a unified ranking framework; (iii) performs integrated inference of required skills and member recommendation using the same semantic representation space; and (iv) systematically generates and uses prompt sentences to control generative AI models for explanation and re-evaluation, while incorporating user emotion or urgency into the ranking and presentation logic. Such a technique should improve the efficiency, accuracy, and consistency of project-related information retrieval and recommendation, thereby improving the functioning of the underlying computer system itself rather than merely automating a manual process.

The specific processing by the specific processing unit 290 of the data processing device 12 in Example 1 is realized by the following means.

The present invention provides a server comprising a processor configured to acquire natural language text representing contents of a project from a terminal operated by a user, perform structured preprocessing of the natural language text including morphological analysis, syntactic analysis, named entity extraction, and removal of unnecessary words, and extract, from the preprocessed text, keywords and phrases related to an objective of the project and required resources, while generating one or more prompt sentences that explicitly instruct execution of such preprocessing and extraction; to generate, based on the extracted keywords and phrases and the natural language text, a feature vector representing semantic contents of the project by using a natural language processing model or a similarity calculation model that outputs distributed representation vectors, and to generate one or more prompt sentences that instruct identification of similar or related projects based on the feature vector; to generate one or more prompt sentences that instruct a data storage device to execute word-based searching using the extracted keywords and vector-based searching using the feature vector and to acquire past projects, related materials, and member information, and to integrate word-based search results and vector-based search results into integrated search results ranked according to relevance; to estimate skills required for the project based on at least the natural language text and the integrated search results, compare the estimated skills with skill information and past project participation histories of members, specify candidate members suitable for the project, and generate one or more prompt sentences that instruct execution of the comparison and specification; to construct structured data including the contents of the project, the similar or related projects, the related materials, and information of the candidate members, and generate one or more prompt sentences that instruct a generative AI model to generate an explanatory text including at least a summary and recommendation reasons, to obtain the explanatory text generated by the generative AI model in response to the prompt sentences, and to control presentation of the explanatory text in association with the integrated search results to the terminal; and to analyze emotion or urgency of the user based on at least the input text of the user or an operation history of the user, and generate one or more prompt sentences that instruct adjustment of a presentation order or emphasis level of the integrated search results and the candidate members in accordance with an analysis result, and to update and re-present search and recommendation results by issuing additional prompt sentences to the generative AI model when an additional prompt sentence is input by the user. This enables the computer system to internally transform unstructured project descriptions into semantically meaningful feature representations, orchestrate heterogeneous search mechanisms through prompt-controlled workflows, and dynamically refine member recommendations and explanatory outputs with reduced latency and improved ranking quality, thereby enhancing the efficiency and technical performance of project-related information retrieval and recommendation beyond conventional keyword-based or rule-based systems.

The term “natural language text” refers to character string data expressed in a human language, including sentences, phrases, and words, which is not pre-structured in a formal programming or markup language and is intended to describe contents of a project.

The term “project” refers to a planned set of activities or tasks directed to achieve a particular objective or deliverable within an organization, including associated requirements, constraints, and resources.

The term “terminal” refers to an information processing device, such as a client computer, a mobile device, or a display apparatus, that is operated by a user to input project-related information and receive processing results from a server.

The term “processor” refers to one or more hardware processing units, such as a central processing unit or a graphics processing unit, configured to execute instructions that implement the functions of the server.

The term “preprocessing” refers to a series of computational operations applied to natural language text, including at least tokenization, morphological analysis, syntactic analysis, named entity extraction, and removal of unnecessary words, for the purpose of generating data suitable for subsequent analysis.

The term “morphological analysis” refers to processing that segments a text into word units or morphemes and assigns grammatical or lexical attributes to each unit.

The term “syntactic analysis” refers to processing that determines structural relationships between words or phrases in a text, such as dependency relations or phrase structures.

The term “named entity extraction” refers to processing that identifies and classifies expressions in a text that refer to entities such as persons, organizations, locations, products, or time periods.

The term “unnecessary words” refers to tokens, such as function words, fillers, stop words, and punctuation, that are deemed to have low contribution to semantic discrimination for a specific analysis task.

The term “keyword” refers to a term or phrase extracted from a text that has relatively high importance or relevance to the main subject, objective, or required resources of a project.

The term “phrase” refers to a group of one or more words forming a meaningful unit within a text, often corresponding to a noun phrase or verb phrase, that captures an aspect of the project contents.

The term “prompt sentence” refers to a text instruction generated by the processor, formatted as natural language or a structured command, which specifies a processing request or control directive to a search subsystem, a data storage device, or a generative AI model.

The term “natural language processing model” refers to a computational model, implemented by software and executed by hardware, that processes natural language text to perform tasks such as tokenization, tagging, classification, or embedding generation.

The term “similarity calculation model” refers to a computational model that maps input data to numerical representations and computes similarity scores, such as cosine similarity or distance metrics, between such representations.

The term “distributed representation vector” refers to a numerical vector in a multi-dimensional space that encodes semantic or contextual features of an input text, such that semantically similar texts correspond to vectors located close to each other in the space.

The term “feature vector” refers to a distributed representation vector generated from a project's natural language text and associated keywords or phrases, which numerically represents semantic characteristics of the project.

The term “data storage device” refers to a hardware or virtual storage resource, such as a database system or a file storage system, that stores past project data, document data, or member data and responds to search queries.

The term “word-based searching” refers to retrieval processing that uses textual tokens, such as keywords or phrases, to match against indexed terms in a data storage device, typically using inverted indexes or full-text search mechanisms.

The term “vector-based searching” refers to retrieval processing that uses feature vectors representing semantic contents of data items, and identifies similar items by computing vector similarity measures, such as cosine similarity or distance.

The term “integrated search results” refers to a combined result set obtained by merging word-based search results and vector-based search results and optionally re-ranking them according to one or more relevance criteria.

The term “past projects” refers to records stored in a data storage device that describe previously executed projects, including at least a project name, a description, and optionally associated metadata.

The term “related materials” refers to digital resources, such as documents, reports, specifications, and templates, that have a semantic or contextual relationship to a given project.

The term “member information” refers to data describing individuals who may participate in a project, including at least identification information, skill information, and past project participation histories.

The term “skill” refers to an ability, competence, or technical capability of a member, expressed as a label or description, that can be matched to requirements of a project.

The term “estimated skills” refers to one or more skills inferred by the processor as being required for a project, based on analysis of the project's natural language text and associated search results.

The term “skill information of members” refers to stored data describing skills possessed by each member, including skill names, proficiency levels, categories, and optionally certifications.

The term “past project participation history” refers to data indicating, for each member, which past projects the member has participated in and in what role, including associated time periods or responsibilities.

The term “candidate member” refers to a member selected by the processor as a potential participant in a project based on compatibility between estimated skills and member skill information and past project participation histories.

The term “structured data” refers to data organized in a machine-readable format, such as key-value pairs, tables, or objects, that represent project contents, search results, and member information in a structured manner.

The term “generative AI model” refers to a machine learning model, such as a neural network, configured to generate natural language text or other content based on input data and prompt sentences.

The term “explanatory text” refers to natural language output generated by a generative AI model that provides a summary, explanation, or recommendation reasoning regarding a project, search results, or candidate members.

The term “summary” refers to a condensed representation of the main points of project contents or retrieved information, expressed in natural language text.

The term “recommendation reasons” refers to explanatory statements that describe why certain projects, materials, or members are considered relevant or suitable for a given project.

The term “presentation control” refers to operations by which the processor determines how, in what order, and in what form search results, explanatory texts, and recommendations are provided to a terminal for display.

The term “emotion” refers to an inferred affective state of a user, such as urgency, frustration, satisfaction, or stress, derived from analysis of user input text or user interaction patterns.

The term “urgency” refers to a degree of time-criticality or priority inferred from user input or behavior, indicating how quickly the user requires relevant information or recommendations.

The term “operation history” refers to records of interactions between a user and the system, including input events, navigation actions, selection actions, and timing information.

The term “presentation order” refers to a sequence in which items in search results or candidate member lists are arranged and displayed to a user.

The term “emphasis level” refers to a degree of visual or structural highlighting applied to particular items, such as by ordering, grouping, or annotation, in relation to other items in a result set.

The term “additional prompt sentence” refers to a prompt sentence that is explicitly provided by a user after initial results have been presented, to request re-evaluation, refinement, or re-focusing of search or recommendation processing.

The term “re-evaluation prompt sentence” refers to a prompt sentence generated by the processor, based on an additional prompt sentence and internal data, that instructs a generative AI model to re-evaluate relevance of items or re-select candidate members.

The term “workflow” refers to an ordered or partially ordered set of processing steps executed by the processor, including at least project input processing, keyword extraction, feature vector generation, data storage device searching, member recommendation, and explanatory text generation.

In one embodiment, a server cooperates with one or more terminals operated by users to implement a project-support system that performs semantic analysis, multi-modal search, member recommendation, and controlled interaction with a generative AI model. The server includes at least one processor, a memory storing executable instructions and data structures, and one or more storage devices. The terminal includes a processor, a display device, an input interface, and a communication interface.

The server uses general-purpose computing hardware, such as an x86 or ARM-based central processing unit, optionally combined with an accelerator such as a graphics processing unit. The server stores and executes software components including an operating system (for example, a UNIX-like operating system), a web application framework (for example, a server-side scripting framework), a relational database management system (for example, relational database software), a natural language processing library (for example, a tokenization and tagging library), a machine learning framework (for example, a tensor computation framework), and a vector indexing library or service (for example, a high-dimensional vector index). The server may further communicate with an external generative AI model via an application programming interface exposed by a remote computation service.

The terminal executes client software such as a web browser or a dedicated application. The terminal sends natural language project descriptions and optional prompt sentences to the server via a communication network using a protocol such as HTTPS, and receives structured results and explanatory texts from the server to be rendered on the display.

In one concrete configuration, the server stores natural language project descriptions as character strings in a projects table of a relational database. Each project entry is associated with metadata fields including a project identifier, a user identifier, timestamps, and references to extracted features. The server stores tokenized and normalized representations of the project text in a separate table or column, such as an array of tokens. The server also stores extracted keywords, phrases, and scores in a keyword table with fields representing the project identifier, keyword string, and numerical importance score. The server stores feature vectors in a vector storage module, which can be implemented as a dedicated vector store or as a database extension, where each vector is associated with a project identifier and is stored as an array of floating-point numbers.

The server uses a natural language processing model to transform the raw text into a form suitable for further computation. The server applies tokenization, part-of-speech tagging, and named entity recognition through a sequence of modules. For example, the server loads a model file that defines a vocabulary and parameters of a neural network used for tagging. The server applies the model to the token sequence to output tags and entity labels. The server then removes stop words by comparing tokens against a predefined stop-word list stored in memory. This preprocessing yields a reduced set of terms that carry higher semantic information density. By doing so, the server reduces dimensionality and noise before subsequent vectorization, which improves both accuracy and computational efficiency of downstream similarity calculations.

The server generates a distributed representation vector (feature vector) for each project description. The server uses a neural network-based encoder, such as a transformer encoder with multiple self-attention layers, residual connections, and layer normalization. The encoder is pre-trained and optionally fine-tuned using domain-specific corpora. The server inputs the normalized character string or token sequence into the encoder, which maps the sequence to an embedding vector of fixed length by applying linear transformations, attention mechanisms, and non-linear activation functions. The server averages or pools token embeddings to produce a single vector for the entire project. The server then normalizes the resulting vector using an L2 normalization routine implemented by numeric libraries. Because semantically similar project descriptions yield vectors with small angular distance, the server later performs efficient nearest-neighbor search based on cosine similarity.

The server uses a keyword extraction algorithm such as TF-IDF or a neural keyword extractor. In a TF-IDF configuration, the server calculates term frequencies for each token in the project text and multiplies them by inverse document frequencies stored in a global statistics table. The server then sorts terms by their TF-IDF scores and selects top-ranked terms as keywords. In a neural approach, the server uses an auxiliary model that estimates a relevance score for each candidate phrase. In both cases, the server stores keyword strings and associated relevance values.

The server interacts with one or more data storage devices that store past project records, document metadata, and member profiles. The server maintains an inverted index for keyword-based search, where the index maps term strings to lists of document identifiers. The server also maintains a vector index for vector-based search, which stores high-dimensional feature vectors and supports nearest-neighbor queries. When the server receives a search request, the server retrieves both keyword-based results from the inverted index and vector-based results from the vector index and then merges these result sets. The server assigns weights to scores from each modality, normalizes them, and computes a combined relevance score. This integration reduces cases where purely keyword-based methods fail due to vocabulary mismatch and cases where purely vector-based methods introduce semantically vague matches.

The server stores member profiles in a member table that includes fields such as member identifier, department, skills text, and past project participation identifiers. The server generates feature vectors for each member's skills text and project history using the same or a compatible semantic encoder used for project descriptions. As a result, both projects and members share a common vector space. When the server estimates required skills for a given project, the server compares the project vector with member vectors, computes similarity scores, and ranks members. Because these vectors capture distributional semantics of both task descriptions and skill labels, the server can identify non-trivial matches that are not readily identifiable by exact keyword matching.

The server uses a generative AI model to generate explanatory texts that summarize search results and recommendation rationale. The server does not merely pass through free-form user inputs; instead, the server constructs structured prompt sentences that explicitly encode instructions and incorporate machine-readable data. For example, the server may generate a prompt sentence:

“You are an assistant for project resource planning.

Project description: [text of the project]

Similar projects: [short bullet list of titles and purposes]

Related documents: [short bullet list of document titles]

Candidate members: [short bullet list of names and skills]

Summarize the project and explain which past projects, documents, and members are most relevant and why. Respond in concise English.”

By constructing a prompt sentence that embeds selected structured data, the server constrains and controls the generative AI model's behavior, which leads to more stable and predictable outputs. The server records the prompt sentence and the model's response in a log data structure, which can be analyzed to refine future prompt generation strategies.

In another example, the server generates a prompt sentence for skill extraction:

“You are an expert in project planning.

Project description: ‘We will conduct a new product market research project targeting Japanese consumers. We need to analyze consumer behavior and competitors, and design online and offline questionnaires.’

List the concrete skills required for this project as short phrases, one skill per line.”

The server then parses the generative AI model's response line by line and maps each line to a standardized skill label using a mapping table or clustering algorithm. The server merges these skills with skills independently inferred from rule-based patterns or classifier outputs to enhance coverage and accuracy.

The server further uses prompt sentences to support re-evaluation triggered by user-provided refinement queries. For example, when a user enters:

“Please focus on members with experience in online surveys for Japanese consumers and update the recommendations.”

the server constructs a re-evaluation prompt sentence along the lines of:

“Current project: [short project description]

Current candidate members: [list of members and skills]

User preference: focus on ‘online surveys for Japanese consumers'.

Re-rank the candidate members and recommend the top ones that best match this preference.

Provide a short explanation for each recommended member.”

The server then applies a parser to the generative AI model's output to extract updated rankings and explanations.

The server improves computer technology in several ways. The server uses combined vector-based and keyword-based indexing to reduce overall search latency and to increase relevance. Because the server performs L2 normalization and cosine similarity computations in a vector index optimized for approximate nearest neighbors, the server reduces processor cycles and memory accesses compared to brute-force similarity computations on unindexed vectors. The server's ability to discard low-quality matches early by using a coarse-grained pre-filter (such as a cluster assignment or locality-sensitive hashing bucket) further reduces the system's computational load.

The server also improves accuracy by consistently operating in a unified representation space. By encoding project descriptions, skills, and member histories using compatible encoders, the server avoids inconsistencies between different feature spaces that would otherwise require additional conversions or heuristics. The server uses a trained neural network, such as a transformer model fine-tuned on a corpus of project descriptions and skill annotations. The server trains this model by minimizing a contrastive loss function that encourages representations of similar projects or project-skill pairs to be close, and representations of dissimilar pairs to be distant. During training, the server updates model weights using a gradient-based optimization algorithm, such as stochastic gradient descent with adaptive learning rates, to minimize the loss function. This training procedure yields an encoder that produces more discriminative vectors than generic word embeddings, resulting in improved retrieval performance and reduced error rate in member matching.

The server employs non-conventional processing sequences that differ from manual workflows and from ordinary business logic. For example, the server uses user emotion or urgency as a signal that modifies ranking weights. The server infers emotion or urgency by analyzing typing speed, repetition of queries, word choices in input text, and interaction patterns stored in an operation history log. The server uses these signals to adjust ranking parameters, such as increasing weight for concise, high-confidence documents when urgency is high, or increasing diversity of presented options when emotion suggests indecision. This dynamic adaptation reduces the number of repeated queries and user interactions, thus reducing network traffic between the terminal and server and lowering processing load on the server.

The server can implement several variants of the neural models. In one embodiment, the server uses a transformer encoder with multi-head self-attention layers and positional encoding for both project text and skill text. In another embodiment, the server uses a Siamese network architecture in which two identical encoders share weights and receive different inputs (project text and member history text). The server trains the Siamese network with pairs of positive and negative examples and optimizes a margin-based loss to separate the similarity distributions. This approach allows the server to refine similarity measurement specifically for the member recommendation task.

The server uses a modular architecture that separates preprocessing, feature extraction, search, recommendation, and generative explanation into distinct modules connected through well-defined data structures. For example, the server uses an internal request object that contains fields for raw text, token lists, embedding vectors, keyword lists, search results, candidate members, and explanation text. Each module reads and writes specific fields, thereby enabling pipeline parallelism. This structured workflow improves cache utilization and reduces redundant computation, such as re-computing embeddings for the same text. The terminal provides a user interface that takes advantage of these server-side improvements. The terminal displays integrated search results that combine document links, project summaries, required skill lists, and recommended members in a single unified view. The terminal highlights items that the server ranks highly based on combined keyword and vector scores and emotion-aware weighting. Because the server has already merged and ranked results, the terminal does not need to perform complex local filtering or sorting operations, which simplifies the terminal implementation and reduces client-side resource consumption.

In another embodiment, the server adjusts the amount of data sent to the terminal according to network conditions or device capabilities. The server may, for example, detect that a terminal is connected over a low-bandwidth network and therefore send compressed summaries or reduced result sets instead of full datasets. The server can use the generative AI model to compress explanations and limit the number of recommended items, which reduces communication load while still conveying essential information. This dynamic adjustment improves scalability and responsiveness of the system.

By combining structured preprocessing, specialized neural encoders, integrated vector and keyword search, learned similarity metrics, controlled prompt generation, emotion-aware ranking adaptation, and generative explanation, the server improves the technical functioning of the computer system. The server reduces search time and computational resources while yielding higher-quality, semantically relevant results and recommendations. These improvements arise from specific data structures, specific model architectures and training methods, and a non-conventional orchestration of search and recommendation processes that go beyond mere automation of human decision-making.

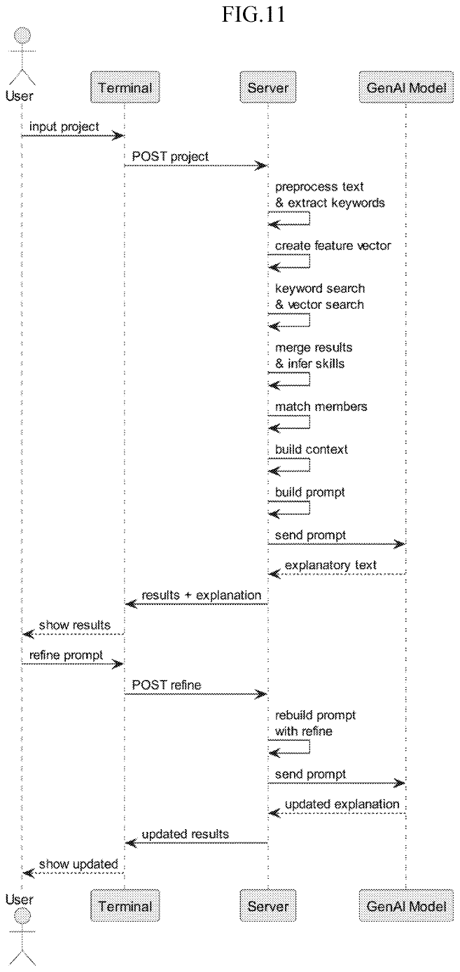

The following describes the processing flow using FIG. 11.

### Step 1

The user operates the terminal to input project information.

The terminal displays an input form including a text area and optional fields for project title and constraints.

Input: raw keystrokes and pointer events from the user.

Processing: the terminal aggregates the keystrokes into a text buffer, validates that mandatory fields are not empty, and checks that the text length does not exceed a predefined limit.

Output: a structured request object in memory on the terminal, containing fields such as project_text, project_title, and user_id.

### Step 2

The terminal sends the project information to the server.

The terminal serializes the request object into a message format such as JSON and establishes an HTTPS connection to the server.

Input: structured request object (project_text, project_title, user_id).

Processing: the terminal encodes the object as a JSON string, attaches HTTP headers including authentication tokens, and transmits the HTTP POST request to a predefined server endpoint.

Output: an HTTP request containing the serialized project information delivered to the server.

### Step 3

The server receives and parses the request.

The server listens on the endpoint and accepts the incoming HTTPS connection.

Input: HTTP request containing JSON-formatted project information.

Processing: the server verifies authentication, decodes the JSON string into internal data structures, and records a log entry including timestamp, user identifier, and a hash of the project text.

Output: an internal project record in server memory, containing raw_project_text, metadata, and a unique project_id.

### Step 4

The server performs text normalization and basic preprocessing.

The server prepares the project text for further linguistic analysis.

Input: raw_project_text associated with project_id.

Processing: the server converts characters to a uniform encoding, lowercases alphabetic characters, removes or normalizes control characters and extra whitespace, and splits the text into sentences and tokens using a tokenization library. The server then removes punctuation and stop words by comparing each token against a stop-word list stored in memory.

Output: a cleaned_token_list and a normalized_text string stored in association with the project_id.

### Step 5

The server performs linguistic analysis to extract grammatical and semantic units.

The server enriches tokens with linguistic annotations.

Input: cleaned_token_list and normalized_text.

Processing: the server applies part-of-speech tagging to each token, determines syntactic dependencies between tokens, and runs named entity recognition to identify entities such as organizations, locations, and product categories. The server constructs phrase chunks (e.g., noun phrases) by grouping contiguous tokens based on syntactic tags.

Output: an annotated_token_list including tags, entity labels, and phrase boundaries, and a phrase_list containing candidate phrases relevant to the project.

### Step 6

The server extracts keywords and key phrases.

The server computes numerical importance scores for terms and phrases.

Input: phrase_list, annotated_token_list, and normalized_text.

Processing: the server calculates term frequencies for tokens and phrases in the project text, retrieves inverse document frequency values from a statistics store, and multiplies them to obtain TF-IDF scores. Alternatively or additionally, the server passes candidate phrases through a learned relevance estimator to obtain scores. The server sorts candidates by score and selects the top entries as keywords.

Output: a keyword_list containing keyword strings and associated importance scores linked to the project_id.

### Step 7

The server generates a semantic feature vector for the project.

The server converts text into a distributed representation suitable for similarity search.

Input: normalized_text and keyword_list.

Processing: the server feeds the normalized_text into a neural encoder, which applies embedding layers, attention layers, and pooling operations to generate an embedding for each token and then aggregates them into a single fixed-length vector. The server optionally augments the input with tagged keywords to bias the representation. The server applies L2 normalization to the resulting vector to prepare it for cosine similarity computation.

Output: a project_feature_vector associated with the project_id and stored in a vector index or a dedicated feature store.

### Step 8

The server performs keyword-based search in the data storage device.

The server uses textual terms to retrieve candidate projects and documents.

Input: keyword_list and data storage index structures.

Processing: the server builds a query consisting of selected keywords and phrases, consults an inverted index that maps terms to document or project identifiers, and retrieves postings lists. The server computes a relevance score for each candidate item based on term matches and weights, then removes items with scores below a threshold.

Output: a keyword_search_result_list containing identifiers and scores of past projects and related materials found by word-based search.

### Step 9

The server performs vector-based search using the semantic feature vector.

The server identifies semantically similar items in a high-dimensional space.

Input: project_feature_vector and a vector index containing stored feature vectors for past projects and documents.

Processing: the server submits the project_feature_vector to a nearest-neighbor query routine in the vector index. The routine calculates similarity measures (e.g., cosine similarity) between the project_feature_vector and stored vectors using approximate search algorithms. The server obtains the top-k nearest items according to similarity, then filters them by metadata such as time range or project category.

Output: a vector_search_result_list containing identifiers and similarity scores of semantically similar projects and materials.

### Step 10

The server integrates keyword-based and vector-based search results.

The server produces a unified ranked result set.

Input: keyword_search_result_list and vector_search_result_list.

Processing: the server aligns items by identifier, merges duplicate entries, and computes a combined score for each item using a weighting function that balances keyword relevance and semantic similarity. The server normalizes scores across both lists, applies an integration policy (e.g., weighted sum or learning-to-rank model), and sorts items by combined score.

Output: an integrated_search_result_list that contains a unified, ranked list of past projects and related materials.

### Step 11

The server estimates skills required for the project.

The server infers an abstract skill set from the text and search results.

Input: normalized_text, keyword_list, and integrated_search_result_list.

Processing: the server applies pattern-based rules to detect skill expressions in the text, such as “data analysis” or “survey design”, and also extracts skill terms appearing frequently in top-ranked result items. The server passes these candidate skills into a classifier or mapping module that normalizes them to standardized skill labels stored in a skill taxonomy. The server may further refine the skill set using a semantic similarity check between candidate skill descriptions and existing taxonomy entries.

Output: a required_skill_list containing standardized skill labels and optionally importance weights.

### Step 12

The server matches required skills to member profiles.

The server computes compatibility scores between the project and members.

Input: required_skill_list, project_feature_vector, and stored member profiles including member feature vectors.

Processing: the server compares required_skill_list with skill labels in each member profile, calculates a skill overlap score, and combines it with a semantic similarity score between project_feature_vector and each member_feature_vector. The server uses a weighting function to combine scores and applies a threshold to filter unsuitable members. The server then ranks the remaining members by combined compatibility score.

Output: a candidate_member_list containing identifiers, names, skill summaries, and compatibility scores of members suitable for the project.

### Step 13

The server constructs structured data for generative explanation.

The server prepares a machine-readable snapshot of the current analysis state.

Input: project_text, integrated_search_result_list, required_skill_list, and candidate_member_list.

Processing: the server selects a subset of top-ranked projects, documents, and members, truncates overly long descriptions, and organizes them into structured fields such as project_overview, similar_projects_summary, related_documents_summary, and candidate_members_summary. The server ensures that total length and structure remain within limits suitable for the generative AI model.

Output: a structured_context_object that encodes relevant information for explanation generation.

### Step 14

The server generates a prompt sentence for the generative AI model.

The server converts structured context into a natural language instruction.

Input: structured_context_object and pre-defined prompt templates.

Processing: the server fills placeholders in a template with content from the structured_context_object. For example, the server may generate a prompt sentence such as:

“You are an assistant for project resource planning.

Project description: [project_overview]

Similar projects: [bullet list from similar_projects_summary]

Related documents: [bullet list from related_documents_summary]

Candidate members: [bullet list from candidate_members_summary]

Summarize the project and explain which past projects, documents, and members are most relevant and why. Answer concisely.”

The server concatenates lines and checks that the prompt length does not exceed model limits.

Output: a prompt_sentence string ready for submission to the generative AI model.

### Step 15

The server sends the prompt sentence to the generative AI model and receives explanatory text.

The server obtains a human-readable explanation and justification.

Input: prompt_sentence and access credentials for the generative AI model.

Processing: the server calls an API of the generative AI model, sending the prompt_sentence as input. The generative AI model returns generated text tokens, which the server collects and assembles into a complete explanatory text. The server may perform minimal post-processing, such as trimming whitespace or splitting into paragraphs.

Output: an explanatory_text that includes a summary and recommendation reasons for the retrieved items and candidate members.

### Step 16

The server analyzes user emotion or urgency and adjusts ranking parameters.

The server uses interaction signals to refine presentation.

Input: user input history, including project_text, optional user comments, and operation logs such as time intervals and repeated queries, and integrated_search_result_list and candidate_member_list.

Processing: the server computes features such as average typing speed, frequency of urgent keywords, and frequency of re-queries. The server applies a classifier or rule set to estimate an emotion or urgency level. Based on this estimate, the server modifies ranking parameters, for example by increasing the weight of higher-confidence documents or decreasing list length. The server recomputes item scores using the updated parameters and reorders the integrated_search_result_list and candidate_member_list accordingly.

Output: an emotion_adjusted_search_result_list and an emotion_adjusted_candidate_member_list tailored to the inferred user state.

### Step 17

The server assembles the final response to the terminal.

The server combines structured lists and explanatory text into a response payload.

Input: emotion_adjusted_search_result_list, emotion_adjusted_candidate_member_list, required_skill_list, and explanatory_text.

Processing: the server formats these items into a structured response object that includes sections for project summary, similar projects, related documents, required skills, recommended members, and explanatory comments. The server ensures that identifiers, display labels, and links are properly associated with each entry.

Output: a response_object suitable for serialization and transmission to the terminal.

### Step 18

The server transmits the response to the terminal.

The server delivers the computed results to be displayed to the user.

Input: response_object.

Processing: the server serializes the response_object into a JSON or other structured format, attaches appropriate HTTP headers, and sends an HTTP response back over the network connection to the terminal.

Output: an HTTP response carrying the structured data and explanatory_text to the terminal.

### Step 19

The terminal receives and renders the results.

The terminal presents integrated search results and explanations to the user.

Input: HTTP response containing the response_object.

Processing: the terminal parses the response payload, populates user interface components such as lists, tables, and text areas, and displays sections for similar projects, related documents, required skills, and recommended members. The terminal may highlight items with higher scores and show the explanatory_text in a dedicated area.

Output: a visual representation on the display that allows the user to inspect projects, documents, skills, and members, and to select items for further action.

### Step 20

The user optionally refines the query with an additional prompt sentence.

The user directs the system to re-evaluate results.

Input: user keystrokes and pointer actions on the terminal's refinement interface.

Processing: the user composes an additional prompt sentence such as “Please prioritize members with extensive experience in online surveys and reduce the number of recommended documents.” The terminal captures this text, packages it with the project_id, and sends a refinement request to the server.

Output: a refinement_request containing the additional prompt sentence and context identifiers, which initiates a new cycle of re-evaluation by the server.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional project management support systems in production environments typically rely on static rule sets, manually curated templates, and simple keyword-based search across stored project records and documents. Such systems suffer from several technical limitations. First, conventional search mechanisms process project descriptions as flat text strings and do not transform the descriptions into machine-interpretable semantic representations, which leads to low recall and precision when retrieving past work information and related material information. Second, existing systems generally treat recommendation of members as a separate, manually driven process that is not tightly integrated with semantic analysis of project requirements, resulting in inefficient matching between project-required capabilities and member capability information. Third, traditional architectures often present fragmented outputs to terminal devices on the shop floor, without a dynamically updated, machine-generated work plan proposal and without real-time re-evaluation of priorities based on incoming progress report information and feedback information.

From a computer-technology perspective, these shortcomings manifest as suboptimal use of processing resources and storage structures. Textual project data, past work information, and capability profiles are not encoded into unified vector spaces or semantic representation vectors, so the processor cannot efficiently compute similarity relationships at scale, nor can it leverage generative artificial intelligence models in a structured way. Furthermore, existing systems typically do not generate machine-formatted prompt sentences that explicitly instruct a generative artificial intelligence model to produce task structures, capability mappings, and document references in a form that can be directly integrated into downstream computational pipelines. This leads to ad hoc, manual usage of generative models, with limited reproducibility, low automation, and increased latency in generating actionable plans.

Additionally, in many conventional systems, progress state information is only updated on a coarse time scale and is not programmatically linked to the semantic structure of the project, so the system cannot automatically re-evaluate priorities of work items, resources, and reference materials in response to continuous inputs from terminal devices. As a result, the processing unit cannot effectively close the loop between planning, execution monitoring, and recommendation refinement, which degrades the overall responsiveness and robustness of the project support platform.

Accordingly, there is a need for an improved computer-implemented system that (i) transforms project description information and required capability information into semantic representation vectors, (ii) generates structured prompt sentences to orchestrate interaction with a generative artificial intelligence model, (iii) integrates outputs from the generative artificial intelligence model with similarity-based retrieval of past work information, related material information, and member capability information, and (iv) continuously updates and re-evaluates progress state information and priorities, while delivering real-time, context-appropriate output information to terminal devices. Such a system would constitute an improvement in computer technology by enabling more efficient data structures, more effective use of machine learning models, and a tighter integration between server-side computation and terminal-side visualization and feedback.

The specific processing by the specific processing unit 290 of the data processing device 12 in Application Example 1 is realized by the following means.

The present invention provides a server comprising a processor configured to acquire description information and required capability information relating to a project; to perform, on the description information, character string normalization, tokenization, part-of-speech analysis, and important term extraction to generate a prompt sentence for instructing a search of information based on contents of the project; to convert the description information and the important terms into semantic representation vectors by inputting the description information and the important terms to a machine learning model that generates distributed representation vectors, to calculate similarity between the semantic representation vectors and semantic representation vectors associated with past work information, related material information, and member capability information stored in a storage device, and to generate a prompt sentence for instructing identification of past work information and related material information that are similar or related on a basis of the similarity; to compare the required capability information relating to the project with the member capability information as semantic representation vectors or attribute vectors, to select, as candidate members, members having capabilities required for the project, and to generate a prompt sentence for instructing presentation of the candidate members as recommended members; to generate a prompt sentence for requesting a generative artificial intelligence model to generate a work plan proposal including work items, required capabilities, and reference materials for each phase of the project, on a basis of the past work information that is similar or related and the related material information; and to update progress state information representing a progress state of the project on a basis of the work plan proposal and the candidate members and to generate output information for transmitting the progress state information to a terminal device. This enables the server to implement an integrated, machine-readable workflow in which project descriptions and capability profiles are transformed into semantic representation vectors, prompt sentences are systematically generated and supplied to a generative artificial intelligence model, similarity-based retrieval of historical records and documents is combined with generative outputs to form a structured work plan proposal, and progress state information and priorities are continuously updated and delivered to terminal devices, thereby improving computational efficiency, recommendation accuracy, and real-time adaptability of the project management support system.

The term “processor” refers to a hardware-based or virtualized computing element, such as a central processing unit, graphics processing unit, or other computation circuitry, configured to execute instructions stored in a memory to perform the functions described herein.

The term “description information” refers to digital data representing a textual or symbolic description of a project, including at least information about objectives, scope, constraints, phases, or tasks of the project.

The term “required capability information” refers to digital data representing capabilities, skills, qualifications, or competencies that are required to execute a project or specific tasks within the project.

The term “character string normalization” refers to processing that converts input text into a canonical form, including at least operations such as case conversion, removal or unification of special characters, whitespace normalization, or encoding normalization, to facilitate subsequent analysis.

The term “tokenization” refers to processing that segments a sequence of characters into smaller units, such as words, subwords, or symbols, which can be individually analyzed by subsequent algorithms.

The term “part-of-speech analysis” refers to processing that assigns grammatical categories, such as noun, verb, adjective, or adverb, to tokens in text, using rule-based, statistical, or machine learning techniques.

The term “important term extraction” refers to processing that identifies tokens or token sequences that are deemed salient for representing the semantic content of text, based on criteria such as frequency, position, syntactic role, or statistical weighting.

The term “prompt sentence” refers to a structured sequence of characters or tokens that is generated by the system to instruct another computational component, including at least a generative artificial intelligence model, to perform a specific operation such as information search, similarity-based retrieval, or generation of a work plan.

The term “distributed representation vector” refers to a numerical vector formed of multiple components, each component being a numerical value, which collectively encode semantic or syntactic characteristics of an input such as text, and which are generated by a machine learning model.

The term “semantic representation vector” refers to a distributed representation vector that encodes at least semantic relationships among words, phrases, or documents, such that similarity or distance between vectors corresponds in part to similarity of meanings.

The term “machine learning model” refers to a parametrized computational model, trained or trainable using example data, that is configured to transform inputs, including at least text tokens or numeric features, into outputs, including at least distributed representation vectors or generated text.

The term “similarity” refers to a numerical measure of closeness between two or more semantic representation vectors or attribute vectors, computed by a function such as cosine similarity, dot product, distance-based metrics, or other correlation measures.

The term “past work information” refers to digital data describing historical projects, tasks, operations, events, or workflows that have been performed previously, including at least summaries, outcomes, or associated metadata.

The term “related material information” refers to digital data representing auxiliary resources associated with projects or tasks, including at least documents, manuals, checklists, diagrams, or digital files that provide reference content.

The term “member capability information” refers to digital data representing attributes of persons or resources that may participate in a project, including at least skills, experience, certifications, roles, or historical participation records.

The term “attribute vector” refers to a numerical vector whose components encode attributes, categories, or features of an entity such as a member, skill profile, or project requirement, in a form suitable for numerical comparison.

The term “candidate members” refers to entities, such as human resources or roles, that are selected by the processor as potential participants in a project based on comparison between required capability information and member capability information.

The term “recommended members” refers to candidate members that are designated by the processor as being suitable for assignment to a project, based on ranking, scoring, or additional criteria.

The term “generative artificial intelligence model” refers to a machine learning model that is configured to generate output data, such as text or structured information, from input data, including at least prompt sentences, by probabilistic or neural network-based generation processes.

The term “work plan proposal” refers to digital data representing a proposed structure of work for a project, including at least work items, required capabilities, reference materials, and their relationships or ordering across phases of the project.

The term “work item” refers to a unit of work or task within a project, defined by at least an action, a target object or process, and optionally associated capabilities and reference materials.

The term “reference material” refers to a resource, such as a document, manual, specification, drawing, or checklist, that is associated with a work item or project phase and is intended to be consulted during execution.

The term “progress state information” refers to digital data representing a status of execution of a project, including at least completion degrees, current phases, active work items, timestamps, or condition indicators.

The term “output information” refers to digital data generated by the processor and intended for transmission to another component, such as a terminal device, the output information including at least progress state information, work plan information, recommendations, or user interface data.

The term “terminal device” refers to a computing apparatus, such as a portable device, stationary console, or embedded controller, that communicates with the server via a network and displays or otherwise outputs information to a user or operator.

The term “network” refers to a communication infrastructure, including at least wired or wireless links and communication protocols, that enables data exchange between the server and one or more terminal devices.

The term “progress report information” refers to digital data transmitted from a terminal device or other source to the server, indicating an updated status of work execution, such as completion of work items, occurrence of issues, or measurements.

The term “feedback information” refers to digital data transmitted from a user or operator to the server, indicating evaluations, corrections, confirmations, or other reactions to the presented work plan proposal, recommendations, or progress state information.

The term “similarity information” refers to digital data representing computed similarity values, similarity rankings, or related metadata obtained from comparison of semantic representation vectors or attribute vectors.

The term “history information” refers to digital data representing past states, events, or outcomes related to projects, work items, members, or resources, including at least logs, completion records, or performance metrics.

The term “dashboard information” refers to digital data formatted to present, in an integrated view, at least a work plan proposal, recommended members, progress state information, and priority evaluations, for display on a user interface.

In one embodiment, a server executes a computer program on general-purpose server hardware including at least one central processing unit, a main memory, a non-volatile storage device, and a network interface. The server runs an operating system such as a general-purpose server operating system and executes an application implemented for example in a scripting language framework such as a web application framework. The server accesses a relational database management system such as a structured query database and a machine learning execution environment such as a tensor-based numerical computation library. The server communicates with at least one terminal over a wired or wireless network. The server stores project-related data, member-related data, and historical work data in the database using predefined data structures. The server stores description information of a project in a table having fields such as a project identifier, a text description, a project type, a target facility, and timestamps. The server stores required capability information in a table having fields such as a project identifier, a capability tag, a capability description, and a required level. The server stores member capability information in a table having fields such as a member identifier, a skill tag, a skill description, a skill level, and associations to past project identifiers. The server stores past work information and related material information in tables representing work records, tasks, and document metadata, each entry being associated with a semantic representation vector.

The server implements a text preprocessing module that performs character string normalization, tokenization, part-of-speech analysis, and important term extraction on description information. The server uses, for example, a natural language processing library to convert the description information into a normalized sequence of tokens. The server lowers case, removes non-informative symbols, and applies Unicode normalization. The server applies part-of-speech tagging to each token and identifies noun phrases and verb phrases that are likely to represent domain concepts. The server computes importance scores for each token or phrase using techniques such as term frequency-inverse document frequency or frequency weighting normalized by document length. The server selects terms having scores above a threshold as important terms and stores the important terms as structured records linked to the project identifier.

The server implements a semantic encoding module using a machine learning model that generates distributed representation vectors. In one example, the server uses a deep neural network comprising an embedding layer, multiple self-attention layers, and a pooling layer, similar to a transformer encoder architecture. The server inputs a tokenized and normalized text sequence to the embedding layer, which maps each token to a dense numerical vector. The server applies multi-head self-attention operations to model relationships between tokens. The server then applies a pooling operation, such as taking the representation of a dedicated classification token or computing a weighted average over token representations, to obtain a single semantic representation vector for the entire text. The server also encodes important terms individually and aggregates their vectors by averaging or concatenation to form an additional semantic representation vector. The server stores these semantic representation vectors in vector-typed columns of the database or in a dedicated vector index.

The server executes a similarity computation module that compares semantic representation vectors of a current project with semantic representation vectors of past work information, related material information, and member capability information. The server computes similarity values using metrics such as cosine similarity, dot product, or Euclidean distance. The server performs the similarity computations using optimized linear algebra routines provided by the numerical computation library, thereby exploiting vectorized operations and hardware acceleration where available. The server ranks past work entries and related documents by similarity value and selects top-ranked entries as similar or related entities. By performing the similarity computations in the vector space, the server reduces the search space compared to naive string matching and improves retrieval accuracy.

The server generates prompt sentences to control interaction with a generative AI model in a structured manner. The server constructs a prompt sentence by programmatically concatenating fixed template segments and project-specific variables, including description information, important terms, identifiers of similar past projects, summaries of related documents, and preliminary candidate members. The server uses explicit instructions within the prompt sentence to request the generative AI model to output structured content such as lists of work items, associated required capabilities, and reference materials for each phase. For example, the server generates a prompt sentence of the following form:

“Act as a manufacturing project consultant. A factory is launching a new smartphone production line.

Project description: ‘Set up a new assembly line for a flagship smartphone model with strict quality control and high throughput.’

Extracted keywords: [‘smartphone’, ‘assembly line’, ‘SMT mounting’, ‘inline AOI inspection’, ‘high throughput’, ‘quality control’].

Similar past projects and outcomes:
Project_123: ‘Smartphone SMT and assembly line setup’, result: ‘achieved high equipment effectiveness within 3 months’.
Project_456: ‘High-speed tablet assembly line with AOI’, result: ‘reduced defect rate significantly’.

Based on this information, list 15 concrete tasks that must be completed before mass production starts.

For each task, provide:
1) Task name,
2) Short description,
3) Required skills (in bullet points),
4) Typical documents or manuals needed (for example, installation manual, standard operating procedure, checklist).

Output the result as plain text with clear section headings.”

The server also generates a prompt sentence targeting member matching, for example: “You are an expert HR and skills-matching assistant for an electronics factory.

Current project: ‘Introduce a fully automated smartphone production line with inline optical inspection and strict quality targets.’

Required skills: [‘SMT line setup’, ‘PLC-based automation control’, ‘AOI inspection’, ‘smartphone quality assurance’].

Available candidates (ID, role, skills, past projects):
Candidate_001: ‘SMT engineer’, skills: ‘SMT setup, reflow profile tuning, AOI basic’, past projects: P100 (smartphone), P101 (tablet).
Candidate_002: ‘Automation engineer’, skills: ‘PLC programming, robot integration, conveyor control’, past projects: P200 (general assembly automation).
Candidate_003: ‘Quality engineer’, skills: ‘AOI tuning, smartphone QA, defect analysis’, past projects: P300, P301 (smartphone quality improvement).

Propose an optimal team of 3-5 members for this project.

For each selected member, explain briefly:
1) Main role in the project,
2) Why this member is suitable based on skills and past projects.”

The server transmits the prompt sentence to the generative AI model through an application programming interface. In one embodiment, the generative AI model resides on a remote computing platform and exposes a network-accessible interface that accepts textual prompts and returns generated textual content. In another embodiment, the generative AI model resides on a local machine learning server that shares a high-speed interconnect with the server. The server sets parameters such as maximum output length, sampling temperature, and decoding strategy to control response determinism and richness. The server then parses the returned text using pattern-based logic or natural language parsing techniques to extract structured representations of work items, required capabilities, and reference materials.

The server uses an internal decision logic that combines similarity-based retrieval results with generative AI outputs. The server defines rules to resolve conflicts, such as preferring tasks that appear both in historical data and in generated suggestions, or downgrading tasks that conflict with existing resource constraints. The server encodes each work item in the database with fields such as task identifier, project identifier, associated capabilities, phase, and links to reference materials. The server also links each work item to the semantic representation vectors of associated documents to enable downstream retrieval and re-ranking.

The server maintains progress state information for each project as structured records that store, for example, a current phase identifier, completion percentages of individual work items, timestamps of last updates, and flags for delays or anomalies. The server updates the progress state information based on both internal computations and external inputs from terminal devices. The server computes derived metrics such as estimated time to completion, workload balance across members, and risk levels using predefined formulas. The server may apply additional machine learning models to predict delays based on historical patterns of progress, although such predictive models are optional.

The terminal operates as a computing apparatus installed near or integrated with production equipment such as industrial robots or assembly lines. The terminal comprises a processor, a display unit, input devices such as a touch panel or physical buttons, and a communication interface. The terminal executes a client application implemented in a high-level programming language or within a web browser. The terminal periodically sends status information to the server, such as completion of particular work items, equipment status codes, error notifications, and operator inputs. The terminal receives output information from the server that includes up-to-date progress state information, next work items to be executed, and reference materials to be consulted.

The terminal displays a real-time dashboard view showing, for example, the current project phase, a list of immediate tasks assigned to the local station, and icons or links to relevant documents. The terminal allows an operator to open a reference manual or checklist and to confirm completion of tasks. The terminal encodes operator confirmations and feedback as structured messages and transmits them to the server. The terminal thereby contributes to a feedback loop in which actual execution state influences future prioritization and recommendations by the server.

The user interacts with the system primarily through a browser-based interface served by the server or through a graphical user interface on the terminal. The user inputs new project description information and required capability information into a form. The user reviews lists of similar past projects, recommended work items, and recommended members generated by the server. The user may adjust selections, for example, by excluding certain members or adding custom tasks. The user may also review generated prompt sentences and associated generative AI outputs for auditability, although exposure of raw prompts is optional.

From a technical standpoint, the server improves computer technology in several ways. The server converts large volumes of heterogeneous textual data into semantic representation vectors using a specialized neural network architecture, enabling efficient nearest-neighbor search and similarity computations in high-dimensional vector spaces. This representation reduces reliance on slow, pattern-based string matching and allows the processor to perform bulk similarity calculations using optimized matrix operations. As a result, the server achieves faster response times and more accurate retrieval compared to conventional keyword-only search engines.

The server organizes project-related data, capability data, and historical work data into structured tables and vector indices that are tightly integrated. The server's design allows joint queries across textual content and vector similarity, reducing the number of separate lookups and network round trips. By embedding vector indices in the same storage system, the server reduces data movement and serialization overhead, which results in lower latency and reduced communication load between storage and application layers.

The server employs explicit, machine-generated prompt sentences as control interfaces for the generative AI model. Unlike ad hoc human-written prompts, the server's prompts follow predetermined templates and incorporate automatically computed context variables, such as similarity rankings and extracted capabilities. This structured prompting enables the generative AI model to produce outputs that align with internal data structures, reducing post-processing complexity and improving end-to-end computational efficiency. Furthermore, because the server automatically composes prompt sentences based on current database contents and semantic representations, the server can adapt prompts dynamically as the system evolves, which is not feasible with purely manual prompting.

The generative AI model in one embodiment is trained as a transformer-based language model on a large corpus of domain-relevant and general text. During training, the model minimizes a loss function such as cross-entropy between predicted and actual tokens by adjusting network weights via gradient descent optimization. The model uses multi-head attention, positional encodings, layer normalization, and residual connections to stabilize learning and capture long-range dependencies. The server may fine-tune this base model on a smaller, curated dataset of project descriptions, work procedures, and technical manuals to specialize its behavior for the target domain. The fine-tuning process uses supervised objectives, such as predicting masked tokens or next sentences, or uses instruction-style supervision where the model learns to map prompt sentences to structured outputs.

By encoding project information and capabilities into vectors and by repeatedly using these vectors in downstream similarity and generation steps, the server exploits statistical regularities that human operators cannot reliably utilize at scale. The server's matching of required capability information to member capability information operates in a high-dimensional vector space, allowing for detection of latent relationships between skills that are not explicitly labeled but are learned from co-occurrence patterns. This matching reduces human error and bias and allows for more precise assignment of members to projects. The server's integration of progress state information with semantic structures leads to improved adaptability. The server stores progress updates in a form that can be mapped back to semantic representation vectors of tasks and capabilities. When the server detects delays or anomalies in particular kinds of tasks, the server can identify semantically similar tasks in other projects and reuse known mitigation actions or reference materials. This semantic linkage between execution state and knowledge base reduces recovery time and improves robustness of the project support system.

The system is not limited to a single configuration. In an alternative embodiment, the server deploys separate neural network models for different subtasks, such as a first model for encoding project descriptions, a second model for encoding capability descriptions, and a third model for generating work plans. In another embodiment, the server uses a recurrent neural network or a convolutional neural network instead of a transformer-based model, depending on deployment constraints. The server may also use approximate nearest-neighbor search algorithms, such as locality-sensitive hashing or graph-based indexing, to further accelerate similarity computations over large-scale vector collections.

In another variant, the terminal is implemented as an embedded controller directly coupled to machine controllers of production equipment. In this case, the terminal not only displays information but also changes machine parameters based on server recommendations, subject to safety constraints. For example, the terminal may adjust inspection sampling rates or conveyor speeds when the server determines that quality metrics or throughput targets are at risk. This configuration reinforces the technical nature of the invention by coupling high-level semantic planning to low-level equipment control in a closed loop.

Because the server uses standardized semantic representation vectors, structured prompt sentences, and integrated feedback loops, the server can automatically adapt to new kinds of projects and new capability definitions without redesigning the underlying data schema. The modular architecture, including the text preprocessing module, semantic encoding module, similarity computation module, prompt generation module, and progress management module, allows each component to be optimized or replaced independently while preserving overall functionality. The combination of these components results in improved processing speed, improved retrieval and recommendation accuracy, reduced communication overhead, and increased reliability of computer-assisted planning and control in real-world operational environments.

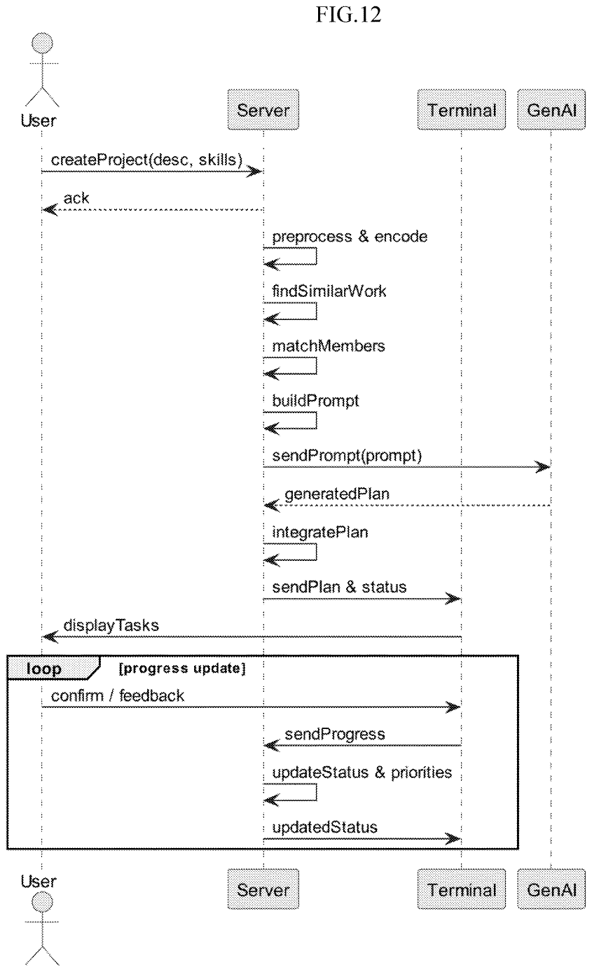

The following describes the processing flow using FIG. 12.

### Step 1

User inputs project information and required capabilities.

User operates a client interface, such as a web browser or a graphical interface on the terminal, and inputs project description information and required capability information. The input includes at least a textual project description, project objectives, target facility, and a list of required skills or capabilities. The input of this step is raw textual and structured project data entered by the user. The output of this step is a structured project request message, for example in JSON format, transmitted over the network to the server.

### Step 2

Server receives and stores project information.

Server receives the project request message through a network interface and parses the message using an application framework. The input of this step is the project request message from the user. The server validates mandatory fields, assigns a unique project identifier, and writes records into database tables corresponding to project metadata, description information, and required capability information. The server may normalize character encodings and store timestamps for traceability. The output of this step is a set of stored database records representing the newly created project and an acknowledgment response returned to the user or terminal.

### Step 3

Server performs text preprocessing and important term extraction.

Server reads the stored description information and required capability information from the database using the project identifier. The input of this step is raw text fields associated with the project. The server runs a text preprocessing module that performs character string normalization (e.g., lowercasing and Unicode normalization), tokenization (splitting text into tokens), and part-of-speech analysis using a natural language processing library. The server computes importance scores for tokens and phrases using statistical methods such as term frequency-inverse document frequency. Based on these scores, the server selects a set of important terms that represent key concepts of the project. The output of this step is a list of important terms and their scores, which the server stores in a project keyword table and passes to the next modules.

### Step 4

Server encodes project and terms into semantic representation vectors.

Server takes as input the normalized description information and the list of important terms obtained in Step 3. The server feeds tokenized sequences into a machine learning model implemented in a neural-network framework, for example a transformer encoder. The model converts tokens into embeddings, applies multiple self-attention layers, and produces a semantic representation vector for the entire description. The server also encodes each important term and aggregates these vectors, for example by averaging, to obtain a secondary semantic representation. The server uses optimized numerical routines to perform matrix multiplications and activation functions. The output of this step is at least one semantic representation vector for the project description and one aggregated vector for important terms, which the server stores in vector fields linked to the project identifier.

### Step 5

Server retrieves and encodes historical data for similarity comparison.

Server queries the database to obtain semantic representation vectors already stored for past work information, related material information, and member capability information. The input of this step is the current project vectors from Step 4 and existing stored vectors from historical records. If some historical entries do not yet have semantic representation vectors, the server encodes their descriptions using the same machine learning model to ensure consistency. The server builds in-memory arrays or batches of vectors to prepare for similarity computation. The output of this step is a collection of standardized semantic representation vectors for both the current project and historical entities.

### Step 6

Server computes similarity and selects similar work and related materials.

Server uses as input the semantic representation vectors for the current project and the collection of vectors for past work and documents. The server computes similarity values using an algorithm such as cosine similarity, implemented with vectorized linear algebra operations. The server calculates a similarity score between the project vector and each historical vector, then sorts the results in descending order of similarity. The server applies thresholds or top-k selection to filter out low-similarity entries. The output of this step is a ranked list of past work information and related material information, each annotated with similarity scores, stored in a temporary or dedicated recommendation table.

### Step 7

Server matches required capabilities with member capabilities.

Server reads the required capability information of the project and the member capability information stored in the database. The input of this step is structured capability records and, optionally, semantic representation vectors for capabilities and members. The server encodes capability descriptions into attribute vectors or semantic representation vectors if not already encoded. The server compares the project's required capability vectors with member capability vectors using similarity metrics and additional rules such as minimum skill levels or availability constraints. The server aggregates similarity scores across capabilities for each member and calculates an overall suitability score. The output of this step is a list of candidate members ranked by suitability, which the server stores as member recommendation records associated with the project.

### Step 8

Server generates prompt sentences for the generative AI model.

Server takes as input the project description, important terms, ranked similar past projects, related material information, and candidate member list generated in previous steps. The server uses a prompt generation module that inserts these elements into predefined text templates. The server constructs prompt sentences that specify the role of the generative AI model, the project context, examples of similar projects and outcomes, and explicit instructions regarding the format and content of the requested output. The server checks that the prompt length stays below a predetermined token limit and truncates or summarizes where necessary. The output of this step is one or more fully formed prompt sentences ready to be sent to the generative AI model.

### Step 9

Server sends prompt sentences to the generative AI model and receives generated content. Server passes the prompt sentences generated in Step 8 to a generative AI model via an application programming interface. The input of this step is the textual prompt sentence and control parameters such as maximum output length and temperature. The server sends an HTTP request or internal RPC call and waits for the response. The generative AI model processes the prompt and returns generated text containing, for example, a sequence of work items, descriptions, required skills, and reference materials. The server receives the response and verifies integrity and status codes. The output of this step is raw generated text from the generative AI model associated with the originating project and prompt.

### Step 10

Server parses generated content into structured work plan data.

Server uses as input the raw generated text from the generative AI model received in Step 9. The server applies text parsing methods, such as regular expression matching, rule-based section detection, or auxiliary natural language parsing, to identify individual work items, corresponding descriptions, required capabilities, and referenced document types. The server maps extracted elements into internal data structures, assigning new task identifiers and linking them to the project identifier. The server normalizes capability names to match existing capability tags and resolves references to document categories. The output of this step is a structured work plan proposal stored in tables representing phases, tasks, and task-capability associations.

### Step 11

Server integrates similarity-based results with AI-generated work plan.

Server combines as input the ranked historical work information and related materials from Step 6, the candidate member recommendations from Step 7, and the structured work plan proposal from Step 10. The server executes a decision logic that cross-checks AI-generated tasks against known historical tasks and documents. The server flags tasks that are strongly supported by historical evidence and may down-rank or mark as tentative tasks that lack historical analogs or conflict with resource constraints. The server enriches AI-generated tasks with links to specific documents retrieved earlier and with references to recommended members who match the required capabilities. The output of this step is an integrated project plan dataset that consolidates historical data, semantic similarity, and generative suggestions.

### Step 12

Server updates project progress state structures and derives initial status.

Server initializes or updates progress state information based on the integrated project plan from Step 11. The input of this step is the consolidated list of tasks, associated members, and document references. The server creates progress records for each task with fields set to initial states, such as “not started,” and calculates derived attributes like expected duration or dependency relationships if available. The server also sets an initial overall project phase and completion percentage at zero. The output of this step is a set of progress state records stored in a progress table, which will be updated during subsequent execution.

### Step 13

Server prepares and transmits summary output information to the terminal.

Server reads the integrated project plan and progress state information and selects portions relevant to each terminal. The input of this step is the project plan dataset, member recommendations, and progress state records. The server formats these data as a compact output structure containing, for example, current phase, next tasks assigned to the terminal's location or machine, and associated reference materials. The server serializes this structure into a response message and sends it over the network to the terminal. The output of this step is a transmitted message containing real-time instructions and status for display and interaction on the terminal.

### Step 14

Terminal receives and presents project information.

Terminal receives the output message from the server through its communication interface. The input of this step is the serialized project status and task information transmitted in Step 13. The terminal parses the message, updates its local state, and renders information on the display, showing current project phase, next work items, and reference material links. The terminal may highlight urgent or time-critical tasks. The output of this step is a visual or audible presentation of relevant project information to an operator at the terminal.

### Step 15

User reviews recommendations and performs local operations.

User observes the information presented on the terminal or through a web interface. The input of this step is the displayed project plan, member recommendations, and progress state information. The user may start executing tasks, open reference materials, confirm task completion, or provide feedback regarding the relevance of recommended tasks or members. The user actions result in interaction events such as button presses or form submissions. The output of this step is a set of user-generated events or confirmations that the terminal packages into status messages.

### Step 16

Terminal transmits progress report and feedback to the server.

Terminal collects user confirmations, equipment signals, and local status indicators. The input of this step is user interaction data and optional machine status data. The terminal constructs progress report information, including task identifiers, completion statuses, timestamps, and any feedback comments. The terminal sends these reports over the network to the server using defined endpoints. The output of this step is a progress report message and optional feedback message received by the server.

### Step 17

Server updates progress state and recalculates priorities.

Server receives progress report information and feedback information from the terminal. The input of this step is the messages sent in Step 16. The server updates corresponding progress state records, marking tasks as “in progress” or “completed” and updating timestamps and completion percentages. The server recalculates derived metrics such as remaining workload, critical path tasks, and risk levels. Based on updated progress information and, if applicable, new similarity computations or AI outputs, the server re-evaluates the priorities of work items, members, and reference materials. The output of this step is an updated set of progress state records and priority rankings stored in the database.

### Step 18

Server regenerates and distributes updated dashboard information.

Server compiles updated project information, including revised progress states and re-evaluated priorities, into dashboard information. The input of this step is the updated records from Step 17. The server generates a structured representation suitable for visualization, indicating, for example, remaining tasks, current bottlenecks, and recommended focus areas. The server transmits refreshed dashboard information to relevant terminals and to user-facing web interfaces. The output of this step is a new cycle of output messages that keep operators and users synchronized with the latest project status, thereby closing the feedback loop of the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional project support systems and information retrieval systems often treat user-provided project descriptions as simple keyword strings and perform only shallow database lookups. As a result, such systems frequently return results that are not semantically aligned with the true intent of the user, especially when the project description is long, unstructured, or uses domain-specific terminology. Further, conventional systems typically separate search processing from generative artificial intelligence processing, such that search queries, similarity calculations, and generative responses are handled in disconnected pipelines. This separation leads to inefficient use of computing resources, duplicated processing of the same input text, and inconsistent outputs across components.

Moreover, existing systems generally do not generate prompt sentences for a generative AI model in a systematic way that leverages structured representations of the project description and similarity relationships with previously stored projects. Instead, prompt sentences are often manually crafted or based on simple templates that do not incorporate embedding-based similarity results, thereby limiting the quality and relevance of generated guidance.

In addition, conventional systems provide search results and AI-generated content in a uniform manner regardless of the user's emotional state, interaction history, or cognitive load. User interfaces commonly present large volumes of information in fixed ranking orders without dynamically adjusting display priority or emphasis based on how the user is currently engaging with the system. This can result in user frustration, reduced discoverability of the most relevant information, and suboptimal support for project planning or decision making. From a computer-technology standpoint, there is a need for an improved system that (i) transforms unstructured project descriptions into structured information using natural language processing, (ii) generates numerical embeddings and performs similarity computations in an integrated manner with a stored collection of past tasks, (iii) automatically constructs context-rich prompt sentences for a generative AI model based on both the structured project representation and similarity results, and (iv) adaptively controls the presentation of results in response to inferred user emotion derived from input or operation signals. Without such an integrated architecture, computing devices cannot efficiently and consistently coordinate database search, embedding-based similarity, generative AI processing, and user-adaptive presentation in a way that improves the overall functioning of the computer system itself.

The specific processing by the specific processing unit 290 of the data processing device 12 in Example 2 is realized by the following means.

The present invention provides a server comprising a processor and a storage device, the processor being configured to acquire description information related to a task that is input by a user via a terminal, analyze the description information by using a natural language processing technique to extract expression sequences, important expressions, and feature quantities, convert the description information into structured information, generate a numerical vector based on the structured information, calculate similarity between the numerical vector and a plurality of numerical vectors stored in the storage device and related to tasks, extract task-related information that is similar or related to the description information, generate a prompt sentence to be input to a generative information processing model based on the description information, the structured information, and the extracted task-related information, instruct the generative information processing model to process the prompt sentence, acquire result information output from the generative information processing model, cause the terminal to present the result information in association with the extracted task-related information, estimate an emotional state of the user based on input information or operation information of the user, and adjust at least one of a display order and an emphasis degree of information presented on the terminal according to the emotional state. This enables a computing system to transform unstructured project descriptions into machine-interpretable structured data, to perform embedding-based similarity computation and database retrieval in a coordinated manner, to automatically produce context-aware prompt sentences for a generative AI model, and to dynamically control user-interface presentation based on inferred user emotion, thereby improving the technical performance and usefulness of the underlying computer technology in supporting project-related information retrieval and decision making.

The term “processor” refers to a hardware logic element or collection of hardware logic elements configured to execute instructions, including but not limited to a central processing unit, a graphics processing unit, or any programmable processing circuitry.

The term “storage device” refers to a hardware component configured to store data and instructions, including but not limited to a semiconductor memory, a magnetic storage medium, or an optical storage medium.

The term “terminal” refers to an information processing apparatus operated by a user and configured to transmit information to, and receive information from, a server, including but not limited to a personal computer, a portable computing device, or a communication terminal.

The term “user” refers to a human operator who interacts with the system by providing inputs, receiving outputs, and initiating processing related to a task or project.

The term “description information” refers to data representing a textual or symbolic explanation of a task, project, or work item, including but not limited to a natural language sentence, a paragraph, or a set of keywords.

The term “task” refers to an activity, project, work item, or objective to be performed or planned, which is characterized by at least one description provided by the user.

The term “natural language processing technique” refers to a computational method for analyzing and processing human language expressions, including but not limited to tokenization, part-of-speech tagging, entity recognition, syntactic parsing, and keyword extraction.

The term “expression sequence” refers to an ordered set of linguistic units derived from description information, including but not limited to a sequence of words, phrases, or tokens representing the content of the description information.

The term “important expression” refers to a linguistic unit, such as a word or phrase, that is determined through analysis to have a relatively high relevance or significance with respect to the meaning or context of the description information.

The term “feature quantity” refers to a numerical or symbolic attribute that represents a characteristic extracted from description information, including but not limited to term frequency values, categorical labels, or embedding-related parameters.

The term “structured information” refers to data representing contents of description information in a machine-interpretable format, including but not limited to a record, a field-value set, or a labeled data structure obtained through natural language processing.

The term “numerical vector” refers to an ordered set of numeric values representing characteristics of description information in a vector space, including but not limited to an embedding generated by a machine learning model.

The term “similarity” refers to a quantitative measure indicating a degree of relatedness or closeness between two numerical vectors or two pieces of information, including but not limited to a value based on cosine similarity, distance metrics, or correlation.

The term “task-related information” refers to data associated with one or more tasks stored in the storage device, including but not limited to titles, summaries, attributes, or numerical vectors corresponding to past tasks.

The term “information set” refers to a collection of data items stored in the storage device and associated with tasks, projects, or other entities, which can be queried or searched by the processor.

The term “generative information processing model” refers to a computational model configured to generate information such as text or other structured data in response to an input, including but not limited to a generative AI model that produces natural language output from a prompt sentence.

The term “prompt sentence” refers to an instruction or input sequence provided to the generative information processing model, including but not limited to a natural language request that specifies a context, a question, or a desired operation.

The term “result information” refers to data output from the generative information processing model in response to a prompt sentence, including but not limited to generated text, summaries, recommendations, or reformulated descriptions.

The term “emotional state” refers to an estimated affective condition of the user, including but not limited to levels of interest, satisfaction, confusion, or stress, inferred from input information or operation information.

The term “input information” refers to data explicitly entered by the user into the terminal, including but not limited to text input, selection operations, or form submissions.

The term “operation information” refers to data representing user interactions with the terminal or system, including but not limited to click patterns, scrolling behavior, dwell times, and navigation sequences.

The term “display order” refers to an arrangement in which items of information are presented on a display screen, including but not limited to ranking, sorting, or grouping of the items.

The term “emphasis degree” refers to a magnitude of visual or presentation highlighting applied to displayed information, including but not limited to font size, color, position, or additional annotations to attract user attention.

The term “constituent element” refers to an entity that participates in execution of a task, including but not limited to a person, a team, a software component, or a hardware resource.

The term “capability information” refers to data describing abilities or properties of a constituent element, including but not limited to skills, experience, performance metrics, or resource specifications.

In one embodiment, a server cooperates with a terminal operated by a user to implement the invention. The server includes a processor, a main memory, a non-volatile storage device, and a communication interface. The server executes software components including an operating system, an application framework, a natural language processing module, an embedding generation module, a similarity computation module, a prompt generation module, a generative AI client module, an emotion estimation module, and a presentation control module. The server may be implemented on general-purpose computing hardware, such as an x86-based machine running a general operating system. The storage device stores a task database that includes records of past tasks, each record having at least a textual description and a precomputed numerical vector.

The terminal includes a processor, a memory, a display, an input interface, and a communication interface. The terminal executes client software such as a web browser or a native application. The terminal displays input screens to the user, transmits user input to the server via a network, and renders search results and generated output received from the server.

The user operates the terminal to input description information for a task, such as a project overview, purpose, or requirements, in natural language. The user may input, for example, the following description: “Development of an image recognition system using AI for quality inspection in a factory.” The terminal transmits the description information to the server as text data via a communication protocol such as HTTPS. The server stores the received text data in memory and in the storage device as part of a transaction log for traceability and performance monitoring.

The server uses a natural language processing module to convert the unstructured description information into structured information. In one embodiment, the server uses a natural language processing library such as a statistical or neural parser loaded into memory. The server tokenizes the input text into tokens, performs part-of-speech tagging, and executes dependency parsing. The server extracts expression sequences corresponding to noun phrases, verb phrases, and domain-relevant expressions by traversing the dependency tree. The server further applies named entity recognition to identify technical terms, domains, or resource names. The server calculates feature quantities including term frequency counts, inverse document frequency values, part-of-speech patterns, and syntactic roles for each expression.

The server represents the structured information in a defined data structure stored in memory, such as a record having fields for tokens, phrase boundaries, entity labels, and feature vectors. The server assigns an identifier to each expression sequence and stores a mapping between expression identifiers and the original character offsets in the description information. By doing so, the server can reference the location and role of each expression in subsequent processing, which enhances precision when generating numerical vectors and prompt sentences.

The server uses an embedding generation module to convert the structured information into a numerical vector. In one embodiment, the server loads a neural network-based sentence embedding model into memory. The model may be implemented as a multi-layer neural network with a transformer encoder architecture, having multiple self-attention layers, feed-forward layers, and normalization layers. The server feeds either the entire description information or a concatenation of selected expression sequences to the embedding model. The server encodes tokens into token IDs, retrieves corresponding embedding vectors from an embedding matrix, passes the vectors through the transformer layers, and obtains a contextual representation for the sequence. The server aggregates token-level representations, for example by mean pooling or by taking the representation of a special classification token, to form a single numerical vector in a high-dimensional space, such as a 384-dimensional or 768-dimensional floating-point vector.

The server normalizes the numerical vector, for example using L2 normalization, to prepare for cosine similarity computation. The server then accesses the task database in the storage device and retrieves stored numerical vectors associated with past tasks. The server loads these numerical vectors into memory in a contiguous array to enable efficient vector operations. The server uses a similarity computation module implemented with numerical libraries to calculate similarity values between the numerical vector derived from the current description information and each stored numerical vector. The server computes cosine similarity using dot products and pre-normalized vectors, and may use vectorized operations or batched computation to reduce processing time and memory bandwidth usage.

The server selects task-related information corresponding to stored tasks whose similarity values exceed a threshold or belong to the top positions in a ranked list. The server retrieves associated attributes from the task database, such as titles, summaries, and metadata. By using a numerical embedding space and cosine similarity rather than simple keyword matching, the server improves the accuracy and robustness of retrieval, particularly for long or domain-specific descriptions. The server thus reduces the number of irrelevant records transmitted to the terminal, which decreases communication load and improves response latency.

The server uses a prompt generation module to construct a prompt sentence for a generative AI model. The server combines the original description information, the structured information, and the extracted task-related information in a single text string, following a predefined template stored in the storage device. For example, the server may generate a prompt sentence as follows:

“You are an AI assistant helping with project planning.

New project:

‘Development of an image recognition system using AI for quality inspection in a factory.’

Similar past projects:
1. Deep learning-based defect detection in manufacturing: [summary text]
2. Real-time visual inspection using convolutional neural networks: [summary text]

Based on the new project and the similar projects, summarize key lessons learned and propose three innovative features that could differentiate the new project.”

The server may generate other prompt sentences, such as:

“Summarize the common technical approaches used in the top 5 similar projects to my new AI project.”

or

“Given my project ‘Development of an image recognition system using AI for quality inspection in a factory’ and these similar projects, propose three innovative features I could add to differentiate my project.”

The server passes the prompt sentence to a generative AI client module. The generative AI client module formats the prompt sentence into a request for a generative AI model hosted either locally or remotely. In one embodiment, the generative AI model is a neural network with an encoder-decoder or decoder-only transformer architecture, trained on large-scale text data. The model includes multiple layers of self-attention and feed-forward networks, each with parameters (weights and biases) stored in dense matrices. The model is trained by minimizing a loss function such as cross-entropy over token predictions using gradient-based optimization, such as stochastic gradient descent with adaptive moment estimation. During training, the model adjusts its parameters to reduce prediction error on next-token prediction tasks, using backpropagation to propagate gradients through all layers.

The server or an external computing resource executes the generative AI model by performing forward passes through the network. The generative AI model receives the prompt sentence as a sequence of token identifiers, transforms them into embeddings, and processes them through attention layers that compute attention scores using dot products and softmax functions. The model outputs probability distributions over vocabulary tokens at each position, and the server or the external resource selects output tokens according to a decoding strategy such as greedy decoding or sampling with temperature. This process generates result information, such as summaries, suggestions, or reformulated descriptions, as a sequence of text tokens.

The server receives the result information from the generative AI model and stores it in memory. The server links the result information with the selected task-related information in a presentation data structure that also contains similarity scores and metadata. The server transfers a subset of this presentation data to the terminal, using compact encoding and pagination as needed to reduce communication bandwidth.

The server includes an emotion estimation module that monitors input information and operation information received from the terminal. The server may use features such as typing speed, frequency of corrections, session duration, scroll depth, click patterns, and frequency of re-queries. The server converts these signals into numerical features and feeds them into a classification model, such as a feed-forward neural network or a gradient-boosted decision tree model. The classification model outputs an estimated emotional state, such as high engagement, confusion, or frustration. The model is trained beforehand using labeled interaction logs stored in the storage device, where each log entry includes interaction features and human-annotated emotional labels. The training process minimizes a loss function, such as cross-entropy, and updates model parameters to improve classification accuracy.

The server uses the estimated emotional state to control the presentation control module. The presentation control module modifies the display order and emphasis degree of items before sending them to the terminal. The server can increase the rank or visual emphasis of highly relevant task-related information when the user appears frustrated, or reduce the amount of information when the user appears overloaded. The server can, for example, adjust font sizes, highlight certain items, or group related items into summaries that are generated by the generative AI model, thereby reducing cognitive load. By integrating emotion estimation and adaptive presentation into the processing pipeline, the server improves the effectiveness of information delivery and reduces unnecessary data rendering at the terminal.

The terminal receives the structured presentation data and renders it using a graphical user interface framework. The terminal displays a list of similar tasks with titles, brief overviews, and similarity scores. The terminal also displays a section containing the result information generated by the generative AI model, such as recommendations or rewritten project descriptions. The user views these outputs on the display and can navigate to detailed task records by interacting with the interface.

The user may further input additional prompt sentences through a dedicated input area on the terminal, for example: “Compare my project to the top 3 similar projects and list potential risks and mitigation strategies.” The terminal transmits the additional prompt sentence along with context identifiers, such as selected task IDs, to the server. The server constructs a new context-rich prompt sentence, combining the user request, the original description information, and summaries of the selected tasks. The server again invokes the generative AI client module and receives tailored result information, which is then transmitted to the terminal for display.

The server, by performing structured natural language processing, embedding-based similarity computation, template-driven prompt generation, and emotion-adaptive presentation control, improves the functioning of the underlying computer system. The server reduces redundant parsing and duplication of effort between search and generative processing by reusing structured information across modules. The server optimizes storage and retrieval by using fixed-dimension numerical vectors and contiguous memory layouts that permit efficient vectorized operations. The server reduces network traffic and response time by selecting a subset of high-similarity records before invoking the generative AI model, thereby avoiding unnecessary processing of low-relevance tasks.

The server also improves computational accuracy and consistency. By using numerical embeddings and defined similarity metrics instead of ad-hoc keyword matching, the server decreases false positives in retrieval and aligns generative outputs more closely with semantically relevant tasks. The server uses explicit data structures for expression sequences, feature quantities, and numerical vectors, which allows deterministic and reproducible processing and facilitates caching intermediate results for repeated queries, further improving processing speed.

In another embodiment, the server may employ different neural network architectures or similarity measures. The server may use a convolutional neural network or a recurrent neural network to produce numerical vectors from the description information. The server may employ similarity metrics such as Euclidean distance or learned metric embeddings in place of cosine similarity. The server may also store numerical vectors in a specialized index structure, such as an approximate nearest-neighbor index, to accelerate similarity searches across large datasets.

In a further embodiment, the server may host the generative AI model locally on a dedicated accelerator device, such as a graphics processing unit, to reduce latency and to optimize internal data paths. The server can batch multiple prompt sentences from multiple users and process them in a single pass through the neural network, thereby utilizing the vectorized computation capabilities of the accelerator device and improving throughput.

In another embodiment, the terminal can be a portable device with limited resources, and the server performs the majority of computationally intensive tasks such as natural language processing, embedding generation, similarity computation, and generative model inference. In yet another embodiment, some lightweight preprocessing, such as basic tokenization or client-side validation, can be performed on the terminal to reduce data transmission size and avoid unnecessary server calls.

By implementing these embodiments, the server and the terminal cooperate to execute specific, technically defined algorithms and data transformations, rather than merely automating human judgment. The use of structured embeddings, defined similarity computations, neural network architectures with explicit training and inference procedures, and emotion-based adaptive presentation leads to measurable improvements in processing speed, retrieval accuracy, bandwidth efficiency, and user interface responsiveness. The system therefore provides a concrete technological improvement to computer-implemented project information retrieval and generative assistance, beyond a generic business or organizational workflow.

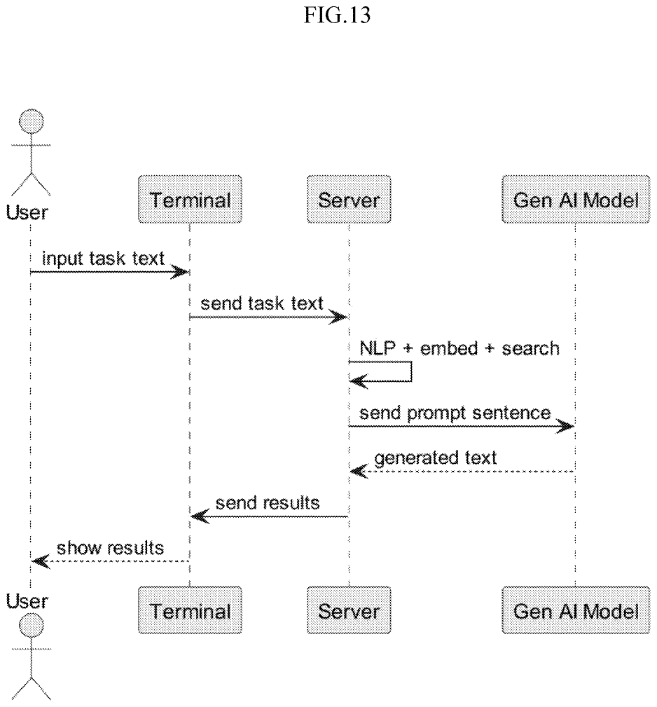

The following describes the processing flow using FIG. 13.

### Step 1

The user operates the terminal and opens an input screen for registering or searching a task. The terminal displays one or more input fields for description information such as a project overview, purpose, and constraints. The user inputs, for example, the text “Development of an image recognition system using AI for quality inspection in a factory.” As input, the terminal receives raw character strings typed by the user. The terminal performs client-side validation and converts the strings into a structured message containing at least a task title and a task description. As output, the terminal generates a text request and transmits it to the server via a network using a communication protocol such as HTTPS.

### Step 2

The server receives the request from the terminal through a communication interface. As input, the server obtains a text payload containing the description information and associated metadata (such as user ID and timestamp). The server parses the payload using an application framework and stores a copy of the raw text in a log storage area. The server then passes the description information to a natural language processing module. As output, the server produces an internal representation of the request, including the raw text and a unique request identifier.

### Step 3

The server performs natural language preprocessing on the description information. As input, the server receives the raw text string and the request identifier. The server tokenizes the text into tokens, assigns part-of-speech tags, and computes a dependency tree using a natural language processing library. The server extracts expression sequences corresponding to noun phrases and verb phrases by traversing the dependency tree and identifies important expressions based on part-of-speech patterns and position in the sentence. The server also calculates feature quantities such as term frequencies and syntactic roles for each token. As output, the server generates structured information that includes a list of tokens, phrase boundaries, identified entities, and numerical feature values for each expression.

### Step 4

The server converts the structured information into a numerical vector. As input, the server receives the list of tokens and associated feature quantities. The server encodes tokens into token identifiers and retrieves token embeddings from an embedding matrix stored in memory. The server feeds the sequence of embeddings into an embedding model, such as a transformer-based sentence encoder, and computes contextualized representations for each token by applying attention and feed-forward operations. The server aggregates the token-level representations using a pooling strategy to produce a single fixed-dimension numerical vector that represents the overall meaning of the description information. The server then normalizes this vector to unit length. As output, the server obtains a normalized numerical vector that can be used for similarity computation.

### Step 5

The server retrieves candidate task vectors from the storage device. As input, the server uses the request identifier, the normalized numerical vector, and optional filtering conditions (such as domain or status). The server issues a database query to the task database to select records that match the filtering conditions and loads stored numerical vectors associated with these records into memory. The server arranges the vectors in a contiguous array to optimize subsequent vector operations. As output, the server produces an in-memory collection of stored numerical vectors and corresponding task identifiers.

### Step 6

The server calculates similarity between the current task vector and the stored task vectors. As input, the server receives the normalized numerical vector for the current description and the array of stored numerical vectors. The server computes cosine similarity by calculating dot products between the current vector and each stored vector, using numeric libraries optimized for matrix operations. The server then sorts the resulting similarity scores and selects the top-ranked tasks or those exceeding a predetermined similarity threshold. As output, the server generates a ranked list of task identifiers with associated similarity scores.

### Step 7

The server retrieves detailed information for similar tasks. As input, the server receives the ranked list of task identifiers and similarity scores. The server issues database queries to fetch task titles, descriptions, and metadata corresponding to the selected identifiers. The server compiles these fields into a structured data set that associates each similar task with its similarity score. As output, the server produces a task-related information set containing detailed descriptions and similarity metrics for each selected task.

### Step 8

The server generates a prompt sentence for a generative AI model based on the description information and the task-related information. As input, the server receives the original description text, the structured information, and the set of similar task descriptions and similarity scores. The server combines these elements according to a template stored in the storage device. The server concatenates the new task description, short summaries of several similar tasks, and an instruction segment that specifies what kind of output is required. For example, the server may generate the following prompt sentence:

“You are an AI assistant helping with project planning.

New project:

‘Development of an image recognition system using AI for quality inspection in a factory.’

Similar past projects:
1. Deep learning-based defect detection in manufacturing: [summary text]
2. Real-time visual inspection using convolutional neural networks: [summary text]

Based on the new project and the similar projects, summarize key lessons learned and propose three innovative features that could differentiate the new project.”

As output, the server produces a complete prompt sentence that embeds both the new description and the context of similar tasks.

### Step 9

The server invokes a generative AI model using the prompt sentence. As input, the server provides the prompt sentence to a generative AI client module, which encodes the prompt into a request format expected by the generative AI model. The server or an external computing resource tokenizes the prompt sentence into token identifiers and feeds them into a trained neural network model with multiple attention layers and feed-forward layers. The model performs a forward pass to compute probability distributions over output tokens at each step and selects output tokens according to a decoding strategy, thereby generating result information such as recommendations, summaries, or reformulated descriptions. As output, the server receives generated text sequences representing the result information.

### Step 10

The server associates the generated result information with the similar tasks and prepares presentation data for the terminal. As input, the server receives the generated text and the task-related information set. The server constructs a presentation data structure that links each similar task with its similarity score and includes sections for AI-generated commentary or suggestions. The server may truncate or segment the generated text to fit display constraints and may attach metadata such as generation time or confidence indicators. As output, the server produces a compact representation of all information to be displayed on the terminal.

### Step 11

The server estimates an emotional state of the user based on interaction signals. As input, the server receives input information and operation information from the terminal, such as typing speed, frequency of query submissions, scrolling behavior, and time spent on each screen. The server converts these signals into numeric features and feeds them into an emotion estimation model. The model computes scores for possible emotional states and selects one or more labels representing the current state, such as high engagement or confusion. As output, the server obtains an estimated emotional state associated with the current session or request.

### Step 12

The server adjusts the presentation data according to the estimated emotional state. As input, the server receives the presentation data structure and the emotional state label. The server modifies the display order by promoting items with higher similarity scores or by prioritizing concise summaries when the user appears overloaded. The server also adjusts emphasis degree by marking certain items as highlighted or by including or omitting detailed explanations depending on the emotional state. As output, the server generates updated presentation data that encodes ranking and emphasis information for each item.

### Step 13

The server transmits the updated presentation data to the terminal. As input, the server uses the final presentation data and the request identifier. The server serializes the data into a response message and sends it to the terminal via the communication interface. The terminal receives the response and parses the data into its internal representation. As output, the server completes the response transmission, and the terminal holds structured content for rendering.

### Step 14

The terminal renders the results and generated content on the display. As input, the terminal receives the structured presentation data including similar tasks, generated texts, similarity scores, ranking positions, and emphasis indicators. The terminal constructs user interface elements such as lists, headers, and highlighted sections. The terminal displays titles and short descriptions of similar tasks in the order specified by the server and applies visual emphasis such as bolding, color changes, or larger fonts according to emphasis indicators. The terminal also displays the generated text from the generative AI model in a dedicated area, for example under a label such as “AI-generated suggestions.” As output, the terminal presents a visually organized view of search results and generative guidance to the user.

### Step 15

The user reviews the displayed information and optionally inputs an additional prompt sentence. As input, the user reads the similar tasks and generated guidance shown on the terminal and decides whether further analysis or reformulation is desired. The user may type, for example, “Compare my project to the top 3 similar projects and list potential risks and mitigation strategies,” or “Rewrite my project overview to be more suitable for an executive presentation.” The terminal captures this additional prompt sentence and associates it with context information such as identifiers of selected similar tasks. As output, the terminal sends a new request containing the user's additional prompt sentence and related context back to the server, which can repeat earlier steps of prompt generation and generative processing using this new input.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented project support systems generally follow a linear pipeline: a server receives a project description, performs a fixed keyword search in one or more data stores, and returns a static list of documents or past projects to a user terminal. Such systems suffer from multiple technical limitations.

First, conventional servers are not configured to automatically decompose rich natural-language project descriptions into machine-usable feature representations and corresponding machine-readable prompt sentences for downstream components. As a result, search conditions for databases and external models are either hand-crafted or based on simplistic keyword extraction, which leads to low recall and low precision in retrieving past activity records, technical materials, and candidate organizational units. This rigid architecture limits the ability of the computer system to adapt to diverse project contexts and complex user queries.

Second, existing systems do not tightly integrate generative information processing models into the core control flow of retrieval and recommendation. In many cases, a generative model, if used at all, is invoked as a separate, loosely coupled module that simply paraphrases or summarizes content. Conventional processors do not systematically generate internal prompt sentences that fuse project features, database results, and session context, nor do they iteratively refine database search conditions based on responses from the generative model. Consequently, the system cannot exploit the reasoning capabilities of generative models to improve the quality and efficiency of information retrieval and recommendation at the computer-architecture level.

Third, existing systems typically treat user emotion, if considered at all, as an external user-interface concern rather than a first-class computational parameter. Conventional servers are not configured to estimate an emotional state from multimodal data (text, audio, image), feed that estimated state into a generative model as part of the model input, and dynamically alter the ordering and content of information provision in response. Because the internal processing pipeline is insensitive to emotional state, the system cannot adapt the prioritization and structuring of results, which leads to inefficient navigation and increased cognitive load for the user.

Fourth, known systems generally maintain a fixed, one-shot interaction pattern between the retrieval logic and the language model. Traditional architectures do not allow the processor to iteratively update search conditions and prompt sentences based on intermediate model outputs and evolving user context. This lack of feedback between the generative model and the search subsystem prevents the system from converging toward more relevant result sets and tailored recommendations over time.

Accordingly, there is a need for an improved computer-implemented system in which a processor: (i) transforms project-related descriptions and prompt sentences into structured feature information and machine-readable prompt sentences; (ii) uses these prompt sentences both to control searches in information storage apparatuses and to orchestrate calls to a generative information processing model; (iii) estimates and exploits user emotional state as a core input to prompt generation and information prioritization; and (iv) iteratively refines search and recommendation behavior based on the generative model's responses. Such an architecture constitutes a concrete improvement in the functioning of the computer system itself, enabling more accurate retrieval, better-organized recommendations, and more efficient human-computer interaction in project support scenarios.

The specific processing by the specific processing unit 290 of the data processing device 12 in Application Example 2 is realized by the following means.

The present invention provides a server comprising a processor configured to receive project-related description information and a prompt sentence from a user terminal, to perform language information processing on the description information and the prompt sentence to extract feature information, to generate, on the basis of the feature information, prompt sentences for issuing search requests to an information storage apparatus that stores past activity information, material information, and organizational-unit information, to acquire similar or related activity information, material information, and organizational-unit information in response to the search requests, to extract capability information required for a project from the description information, to generate a prompt sentence for comparing the capability information with capability information associated with organizational units and to specify organizational units suitable for the project on the basis of a comparison result, to estimate an emotional state on the basis of user input including at least one of text information, audio information, and image information by using an emotion estimation function, to generate a prompt sentence for adjusting an order or importance of information provision on the basis of the emotional state and the acquired activity information, material information, and organizational-unit information, to assign priorities to the information in accordance with the adjustment, to generate an internal prompt sentence including at least the description information, the feature information, the emotional state, and the acquired information, to input the internal prompt sentence to a generative information processing model so as to cause the generative information processing model to generate response information including at least one of summary information regarding the project, recommended procedure information, recommended technology information, and recommended organizational-unit information, and to integrate the response information and the prioritized information to generate display control information for output to the user terminal. This enables the computer system to improve core retrieval and recommendation performance by using structured prompt sentences as control signals for both database search and generative reasoning, to iteratively refine search conditions based on model outputs, and to dynamically tailor the content, ordering, and presentation style of information according to an automatically estimated user emotional state, thereby achieving a concrete improvement in the functioning of the server and a more efficient, adaptive human-machine interaction.

The term “processor” refers to a hardware computation unit or a combination of hardware computation units that executes machine-readable instructions to perform data processing operations, control logic, and communication with storage and external components in the system.

The term “project-related description information” refers to natural-language or structured information that describes at least one aspect of a project, including but not limited to a project objective, scope, requirement, schedule, constraint, or context.

The term “prompt sentence” refers to a machine-readable text expression that encodes an instruction, question, or condition for controlling at least one processing component, including a search function or a generative information processing model.

The term “user terminal” refers to an information processing apparatus operated by a user, such as a computing device equipped with an input interface and a display interface, that transmits information to and receives information from a server.

The term “language information processing” refers to a series of computational operations applied to textual data, including at least one of normalization, tokenization, morphological analysis, syntactic analysis, phrase extraction, semantic analysis, and similarity calculation.

The term “feature information” refers to structured data elements derived from language information processing, including at least one of keywords, phrases, tokens, part-of-speech tags, semantic categories, vector representations, and similarity scores.

The term “information storage apparatus” refers to a storage subsystem, including at least one memory device and a control function, that retains and provides access to records such as past activity information, material information, and organizational-unit information.

The term “past activity information” refers to stored data describing previously executed projects, tasks, or operations, including associated metadata such as outcomes, technologies used, and temporal information.

The term “material information” refers to stored data representing documents, manuals, reports, specifications, guidelines, or other informational resources related to a project or activity.

The term “organizational-unit information” refers to stored data representing structural units or members within an organization, including at least one of names, roles, skills, responsibilities, and affiliations.

The term “capability information” refers to data indicating required abilities, competencies, skills, or knowledge elements associated with a project or an organizational unit.

The term “organizational unit” refers to an identifiable subdivision within an organization, including at least one of a group, team, department, or individual member, that can be assigned responsibilities or tasks.

The term “comparison result” refers to data indicating a relationship or degree of match between two or more sets of information, such as required capability information and capability information associated with organizational units.

The term “user input” refers to information provided by a user to the system through an input interface of a user terminal, including at least one of text information, audio information, and image information.

The term “text information” refers to character-based data, including written natural-language expressions, entered by a user or generated by a component of the system.

The term “audio information” refers to sound-based data, including voice signals or other acoustic signals captured through an audio input apparatus.

The term “image information” refers to visual data, including still images or video frames captured through an image input apparatus.

The term “emotional state” refers to a classification or quantitative representation of a user's affective condition, including but not limited to categories such as stress, frustration, joy, excitement, expectation, or neutrality.

The term “emotion estimation function” refers to a computational function or model that analyzes user input, including at least one of text information, audio information, and image information, to infer an emotional state.

The term “order of information provision” refers to a sequence in which pieces of information are presented to a user, including the relative positioning or ranking of items in a list or interface.

The term “importance of information provision” refers to a relative weighting or priority assigned to pieces of information for presentation, selection, or further processing.

The term “priorities” refers to numerical or categorical indicators that specify the relative importance or display precedence of information items.

The term “internal prompt sentence” refers to a prompt sentence generated by the processor for internal use within the system, which encodes combined context including project-related description information, feature information, emotional state, and acquired information, and is provided as input to a generative information processing model.

The term “generative information processing model” refers to a machine-learned model configured to generate output information, including natural-language text or structured data, from input information such as prompt sentences and context data.

The term “response information” refers to information output from the generative information processing model in response to an internal prompt sentence, including at least one of summary information, recommended procedure information, recommended technology information, and recommended organizational-unit information.

The term “summary information” refers to condensed data representing essential elements of project-related description information or acquired information, expressed in a shorter form than the original.

The term “recommended procedure information” refers to information that specifies one or more suggested sequences of actions, steps, or methods suitable for execution in relation to a project.

The term “recommended technology information” refers to information that identifies one or more technical methods, tools, or approaches suggested as suitable for use in relation to a project.

The term “recommended organizational-unit information” refers to information that identifies one or more organizational units suggested as suitable for assignment to or participation in a project.

The term “display control information” refers to data used by a user terminal to control presentation of information, including layout, ordering, selection, highlighting, and grouping of content on a display device.

The term “similar or related activity information” refers to past activity information that exhibits a similarity or relationship to a current project, as determined by at least one of feature comparison, keyword overlap, or model-based similarity evaluation.

The term “adjusting” refers to modifying at least one parameter governing information provision, including order, importance, selection, or presentation style, based on input conditions such as an emotional state.

The term “iteratively searching” refers to repeatedly performing search operations in an information storage apparatus while successively updating search conditions based on intermediate results or additional input information.

The term “presentation style” refers to a manner of expressing information to a user, including tone, level of detail, organization, and emphasis used in generated text or visual presentation.

The term “presentation order” refers to a sequence in which segments of response information, such as sections or items, are arranged and presented to a user.

In one embodiment, a server executes a project-support program implemented on general-purpose computing hardware. The server includes at least one central processing unit, a main memory, a persistent storage device, and a network interface. The server runs a general-purpose operating system and an application stack comprising a web server component, an application framework, and multiple functional modules for language information processing, database access, emotion estimation, generative AI interaction, and response synthesis.

The server uses software components including, but not limited to, a relational database management system, a full-text search engine, a natural language processing library, and a numerical computation framework for neural networks. The server configures these software components to cooperate through defined data structures and interfaces. The server stores project-related description information, past activity information, material information, and organizational-unit information in one or more databases managed by the database management system and the search engine.

The server stores each project-related description as a record that includes a text field, a project identifier, and metadata such as timestamps and user identifiers. The server stores each past activity as a record including a description field, a feature vector field, and outcome attributes. The server stores each material as a record including a document identifier, a title, and indexed content. The server stores each organizational unit as a record including a unit identifier, associated capability information represented as a list of skill codes or feature vectors, and availability indicators.

The server implements language information processing by using a natural language processing library to transform unstructured text into structured feature information. The server uses tokenization, part-of-speech tagging, lemmatization, and dependency parsing to convert each project description and each prompt sentence into sequences of tokens and syntactic relations. The server constructs term-frequency and inverse-document-frequency values, and the server further computes dense vector representations by applying a pre-trained word embedding model or a transformer-based encoder to the tokens. The server aggregates token-level vectors into a project-level feature vector, for example by weighted averaging or by applying an attention-based pooling layer implemented in a neural network. The server uses the feature information to generate prompt sentences that encode search criteria and comparison tasks. The server constructs a prompt sentence for an information storage apparatus by embedding extracted keywords, semantic categories, and similarity thresholds. For example, the server generates a prompt sentence such as:

“Search for past activities and technical materials related to ‘development of an AI-based image recognition system for quality inspection’ and prioritize those that use deep learning and have high success scores.”

The server transmits this prompt sentence to a search control module that transforms the prompt sentence into concrete queries for the database management system and the full-text search engine. The server uses the feature vectors to compute cosine similarity between the current project and past activity vectors, and the server applies a similarity threshold to filter low-relevance records. The server stores similarity scores in memory along with retrieved record identifiers.

The server extracts capability information required for the project by scanning the parsed project description for terms mapped to a capability taxonomy. The server maintains a capability dictionary that associates phrases such as “convolutional neural network design”, “robotics control”, or “manufacturing line integration” with capability codes. The server constructs a capability requirement vector for the project by aggregating these codes and their weights. The server compares this capability requirement vector with capability vectors stored for each organizational unit by computing distance metrics such as cosine distance or Euclidean distance. The server then generates a prompt sentence that describes the comparison task, for example: “Compare required capabilities for ‘AI-based image recognition system for quality inspection’ with capabilities of available organizational units and select the top five units with highest capability match.”

The server uses this prompt sentence to control a recommendation module that ranks organizational units by match score and constructs recommended organizational-unit information.

The server estimates an emotional state of a user by processing user input that includes at least one of text information, audio information, and image information. The server applies, for text information, a sentiment classification neural network that uses a transformer encoder architecture with multiple self-attention layers, layer normalization, and feed-forward layers. The server trains this neural network in a supervised manner by minimizing a cross-entropy loss over labeled emotion categories such as “stress”, “frustration”, “joy”, and “excitement”. The server updates model weights by using a stochastic gradient-based optimization algorithm and may apply regularization and data augmentation techniques such as synonym replacement for robustness.

The server applies, for audio information, a neural network that receives spectrogram features or Mel-frequency cepstral coefficients as inputs and outputs emotion probabilities. The server uses convolutional layers and recurrent layers (for example, long short-term memory units) to capture temporal patterns in speech. The server trains this network with labeled speech emotion datasets and uses a loss function similar to the text model. For image information, the server applies a convolutional neural network that takes facial images as input and outputs emotion probabilities.

The server fuses the emotion probabilities from the text model, the audio model, and the image model by applying a fusion network or a weighted averaging scheme. The server produces a final emotional state classification and a confidence score. The server stores the emotional state as part of session context and uses it when generating further prompt sentences.

The server generates an internal prompt sentence that includes the project-related description information, the extracted feature information, the retrieved activity information and material information, the organizational-unit information, and the estimated emotional state. The server structures this internal prompt sentence according to a pre-defined template, such as: “The user is planning ‘development of an AI-based image recognition system for quality inspection in a manufacturing line’ and is currently in a state of stress. The following related activities have been retrieved: [summary of activities]. The following technical materials are available: [summary of materials]. The following organizational units have been identified: [summary of units]. Based on this context, generate (1) a concise summary of the project, (2) recommended procedures, (3) recommended technologies, and (4) recommended organizational units, in an order that reduces cognitive load for a stressed user.”

The server inputs this internal prompt sentence to a generative information processing model. The server implements the generative information processing model as a neural network comprising an embedding layer, multiple transformer encoder-decoder blocks, and an output softmax layer over a vocabulary of tokens. The server trains this model using supervised or reinforcement learning from human feedback, with loss functions including cross-entropy for token prediction and auxiliary losses for structural constraints. The server stores model parameters in persistent storage and loads them into main memory for execution.

The server configures the generative information processing model to use the internal prompt sentence as context and to generate response information token by token. The server passes parameters such as decoding temperature and maximum token length to control output variability and length. The server decodes the output tokens into human-readable text segments corresponding to summary information, recommended procedure information, recommended technology information, and recommended organizational-unit information. The server may also generate structured markers in the output to facilitate parsing and integration.

The server integrates the response information and the prioritized information that results from database retrieval and capability comparison. The server constructs display control information that includes an ordered list of documents, an ordered list of past activities, and an ordered list of organizational units, each associated with priority scores and explanatory text segments. The server uses the emotional state to adjust ordering; for example, when the emotional state indicates stress, the server increases the priority of items that contain clear step-by-step instructions, troubleshooting guides, or short summaries, and the server decreases the priority of long theoretical documents.

The server transmits the display control information to the terminal through a network interface using a communication protocol such as HTTPS. The terminal receives the display control information, maps it into user interface components such as lists, panels, and dialog boxes, and displays the information on a display device. The user interacts with the user interface to navigate through recommended items, select documents for viewing, and initiate communication with recommended organizational units.

The user may provide additional prompt sentences through the terminal to refine the system's behavior. For example, the user may input:

“Please focus on reducing false positives in the image recognition model and show past activities with similar issues.”

The terminal transmits this prompt sentence and any updated project-related description information to the server. The server repeats the language information processing, feature extraction, and prompt generation based on the new prompt sentence and the existing session context, thereby modifying the search conditions and generative model input. By iteratively updating prompt sentences and search conditions based on user input and previous model outputs, the server improves retrieval accuracy and recommendation relevance.

The server in this embodiment achieves a technical improvement in computer technology by re-architecting the interaction between retrieval components, neural network models, and user interfaces around structured prompt sentences and feature vectors. The server does not merely automate a human project manager's decision flow; instead, the server uses neural network-based embeddings and emotion-aware prompt generation to dynamically adapt internal search indices and result ordering. Because the server computes vector representations and similarity metrics rather than relying on static keyword matching, the server reduces false negatives and false positives in retrieval, thereby improving precision and recall.

The server reduces processing time and communication load by generating targeted queries derived from feature information, rather than broadcasting broad search queries to all storage components. The server narrows search spaces by using similarity thresholds and structured prompt sentences that constrain query terms and filters. This reduces the number of database records that must be scanned, thereby improving processing efficiency and reducing latency. By feeding back response information from the generative information processing model into the search condition generation process, the server iteratively focuses on regions of the data space that are most relevant, reducing redundant searches and further decreasing computational cost.

The server improves data management by storing feature vectors and capability vectors in dedicated data structures that support efficient vector-based search, such as approximate nearest neighbor indexes. The server's use of such vector indexes enables sub-linear retrieval performance for high-dimensional similarity search, which is not achievable with traditional purely keyword-based approaches. The server's emotion-aware prioritization also improves the effectiveness of information delivery by reducing user navigation time and cognitive overload; this effect is not merely a business process optimization but a direct consequence of modifying the internal operation of ranking algorithms using emotion-derived parameters. The server configures the generative information processing model to operate under non-conventional constraints that reflect technical requirements of the retrieval system. For example, the server may include in the internal prompt sentence explicit markers indicating which sections correspond to document identifiers, which sections correspond to procedure steps, and which sections correspond to organizational-unit identifiers. The server uses these markers to parse the model output deterministically, allowing the server to feed selected output segments back into the search and ranking modules. This structured interplay between generative output and deterministic indexing operations goes beyond ordinary human decision-making and is specifically tailored to improve machine-level computation. The server can implement alternative embodiments by modifying the architecture of the neural networks, the fusion strategy for emotional state, or the data structures used for feature storage. In one alternative embodiment, the server uses a recurrent neural network with attention mechanisms instead of a transformer-based encoder for language information processing. In another embodiment, the server uses a graph-based representation of activities and organizational units, and performs graph neural network computations to propagate context across related nodes. In a further embodiment, the server compresses feature vectors using dimensionality reduction techniques such as principal component analysis to reduce storage and retrieval cost.

The server may also adjust error functions and training regimes for the emotion estimation function and the generative information processing model. For example, the server may use a multi-task learning framework in which the generative model jointly predicts response tokens and auxiliary labels indicating which information category (summary, procedure, technology, organizational unit) each token belongs to. The server uses a composite loss function that combines cross-entropy for token prediction with a classification loss for category labeling. This configuration enables more accurate segmentation of generated text and more reliable integration into the retrieval system.

The terminal in these embodiments may be implemented as a handheld device, a wearable device, or a workstation. The terminal executes a client program that communicates with the server, but the terminal does not perform the heavy neural network computations. The terminal focuses on user interaction, input capture, and display. The user controls the system by entering project-related description information and prompt sentences, by optionally providing voice or image data for emotion estimation, and by selecting recommended items for further action.

Through these configurations, the server, the terminal, and the user cooperate to implement the claimed system. The system improves the functioning of the computer as a project-support apparatus by: using feature vectors and neural networks to enhance retrieval and recommendation accuracy; using structured prompt sentences to coordinate database search and generative reasoning; using multimodal emotion estimation to modify ranking and summarization at the algorithmic level; and iteratively refining internal search and recommendation parameters based on model outputs. These technical features provide measurable benefits such as increased retrieval precision, reduced query latency, and reduced user navigation time, thereby demonstrating that the invention is a specific technical solution that improves computer technology rather than an abstract idea implemented on generic hardware.

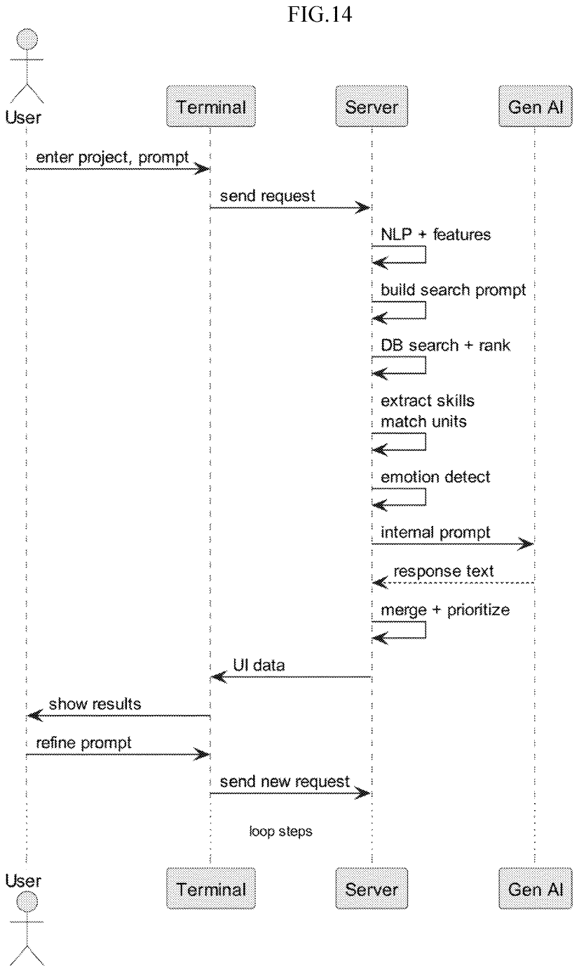

The following describes the processing flow using FIG. 14.

### Step 1

The user inputs project information and a prompt sentence.

The user uses the terminal to enter project-related description information (for example, title, purpose, required technologies, constraints) and a prompt sentence (for example, “Please search related internal projects and recommend suitable technologies and members.”) into input fields.

The terminal receives these text strings as input, packages them into a structured message (for example, with fields “project_description” and “user_prompt”), and sends the message to the server via a network request.

The output of Step 1 is a network request containing raw project text and a prompt sentence that is delivered to the server.

### Step 2

The server performs language normalization and parsing.

The server receives, as input, the project description and the prompt sentence from the terminal. The server converts the text to a standard character encoding, removes control characters, and normalizes whitespace. The server then uses a natural language processing library to tokenize the text, perform part-of-speech tagging, lemmatization, and dependency parsing.

The server computes, as data processing, token sequences, part-of-speech tags, syntactic dependencies, and normalized lemmas from the raw text.

The output of Step 2 is structured linguistic data that represent the project description and the prompt sentence as token-level and sentence-level annotations.

### Step 3

The server generates feature information and semantic representations.

The server takes, as input, the structured linguistic data from Step 2. The server computes term-frequency and inverse-document-frequency values for words, extracts key phrases, and generates dense vector embeddings using a language representation model. The server aggregates word-level vectors into document-level feature vectors using weighted averaging or attention-based pooling.

The server thereby transforms textual descriptions into numerical feature vectors and keyword sets by applying vector computations and aggregation operations.

The output of Step 3 is feature information that includes keyword lists, phrase lists, and one or more feature vectors for the project and the prompt sentence.

### Step 4

The server generates search-oriented prompt sentences for information retrieval.

The server receives, as input, the feature information from Step 3. The server selects high-weight keywords and semantic categories, and then constructs a search-oriented prompt sentence that encodes search criteria, target types (past activities, materials, organizational units), and thresholds. For example, the server generates: “Search for past activities and technical materials related to ‘AI-based image recognition system for quality inspection’ and prioritize those that use deep learning and have high success scores.”

The server concatenates keywords and conditions into a natural-language control string that can be interpreted by a search control module or a generative AI model.

The output of Step 4 is at least one search-oriented prompt sentence that represents machine-readable search criteria derived from the project description.

### Step 5

The server translates search-oriented prompt sentences into database queries and executes retrieval.

The server uses, as input, the search-oriented prompt sentence and the feature information from previous steps. The server parses the prompt sentence, extracts search conditions such as keyword sets, similarity thresholds, and document types, and then generates structured queries for a relational database and a full-text search engine.

The server executes these queries against an information storage apparatus that stores past activity information, material information, and organizational-unit information, and computes similarity scores between feature vectors of the current project and stored vectors. The server filters records that do not satisfy the search conditions or similarity thresholds.

The output of Step 5 is a set of retrieved records representing similar or related activities, materials, and organizational-unit candidates, each with associated similarity scores or relevance scores.

### Step 6

The server extracts and structures capability requirements from the project description. The server receives, as input, the parsed project description from Step 2 and the feature information from Step 3. The server scans the tokens and phrases for terms associated with capabilities according to a capability dictionary or taxonomy. The server then maps each matched term to one or more capability codes and calculates weights based on frequency and context.

The server aggregates these capability codes and weights into a capability requirement vector using vector addition or weighted averaging.

The output of Step 6 is structured capability information for the project, including a capability requirement vector and a list of required capability codes.

### Step 7

The server compares capability requirements with organizational-unit capabilities and ranks units.

The server takes, as input, the capability requirement vector from Step 6 and organizational-unit capability vectors retrieved in Step 5 or from a personnel database. The server computes similarity metrics, such as cosine similarity, between the requirement vector and each organizational-unit vector. The server then ranks organizational units according to similarity scores and removes units that do not meet minimum similarity thresholds or availability constraints.

The server thereby performs numerical comparisons between vectors to identify best-matching organizational units for the project.

The output of Step 7 is a ranked list of organizational units with associated match scores and basic profile data.

### Step 8

The server estimates a user emotional state from multimodal input.

The server receives, as input, user text expressing feelings (for example, “I feel under time pressure”), and optionally audio signals and image frames transferred by the terminal. The server feeds the text through a trained text-based emotion classification network, feeds the audio through a speech-based emotion network using spectrogram features, and feeds the images through a facial-expression network based on convolutional layers.

The server computes, as data processing, emotion probability distributions from each network and then fuses these distributions using a weighted combination or a fusion network to obtain a final emotional state classification (for example, stress, frustration, joy) and a confidence value.

The output of Step 8 is a detected emotional state label and an associated confidence score stored in the session context.

### Step 9

The server generates an internal prompt sentence for a generative AI model.

The server uses, as input, the project-related description information, the feature information, the retrieved activity and material information from Step 5, the ranked organizational units from Step 7, and the emotional state from Step 8. The server constructs an internal prompt sentence that encodes this context in a structured natural-language template, for example: “The user is planning ‘development of an AI-based image recognition system for quality inspection in a manufacturing line’ and is currently in a state of stress. The following related activities have been retrieved: [summaries]. The following technical materials are available: [summaries]. The following organizational units have been identified: [summaries]. Based on this context, generate (1) a concise summary of the project, (2) recommended procedures, (3) recommended technologies, and (4) recommended organizational units, in an order that reduces cognitive load for a stressed user.”

The server concatenates contextual data and control instructions into a single text that specifies the generative task.

The output of Step 9 is an internal prompt sentence suitable as input to a generative AI model.

### Step 10

The server invokes the generative AI model and generates response information.

The server provides, as input, the internal prompt sentence from Step 9 to a generative AI model implemented as a neural network with transformer encoder-decoder blocks. The server forwards model parameters such as maximum output length and decoding strategy. The generative AI model processes the prompt sentence by encoding it into hidden representations and decoding a sequence of output tokens that describe summaries, recommended procedures, technologies, and organizational units.

The server collects the output token sequence, decodes it into text strings, and optionally splits the text into labeled sections based on markers or headings.

The output of Step 10 is response information that includes at least a project summary, recommended procedures, recommended technologies, and recommended organizational-unit suggestions in natural-language form.

### Step 11

The server performs emotion-aware prioritization and merging of response information with retrieved data.

The server receives, as input, the response information from Step 10, the retrieved records from Step 5, the ranked organizational units from Step 7, and the emotional state from Step 8. The server calculates new priority scores for each document, activity, and organizational unit by combining similarity or match scores with weighting factors derived from the emotional state (for example, increasing weights for concise step-by-step guides when the user is stressed).

The server merges the ranked items with the textual recommendations from the generative AI model, associates explanations to each item, and constructs ordered lists for display.

The output of Step 11 is prioritized, structured content sets (documents, activities, organizational units) aligned with the emotional state and supported by generative explanations.

### Step 12

The server generates display control information and sends it to the terminal.

The server uses, as input, the prioritized content sets and the generative explanations from Step 11. The server formats this information into display control information that specifies, for each item, its display position, title, summary, explanation text, and links or identifiers for retrieval. The server encodes this information in a structured response message and transmits it to the terminal via the network interface.

The output of Step 12 is a response message that instructs the terminal how to organize and present items on the user interface.

### Step 13

The terminal renders the user interface and supports user interaction.

The terminal receives, as input, the display control information from Step 12. The terminal maps items and their priorities to UI components such as lists, panels, tabs, and buttons, and draws these components on a display device in the specified order and grouping. The terminal updates interactive elements so that the user can open documents, inspect recommended procedures, and view organizational-unit details.

The terminal outputs a rendered graphical interface that presents prioritized content and explanations to the user, and the terminal is ready to capture further user actions.

### Step 14

The user reviews results and optionally refines the request with a new prompt sentence.

The user observes, as input, the displayed summaries, recommended procedures, recommended technologies, and proposed organizational units. The user evaluates the usefulness of the information and, if necessary, enters a refined prompt sentence such as “Please focus on reducing false positives in the image recognition model and show past activities with similar issues.”

The terminal captures this refined prompt sentence, packages it with updated project context, and sends it back to the server.

The output of Step 14 is a new request containing updated user instructions that the server uses to repeat or refine Steps 2 through 12, enabling iterative improvement of retrieval and recommendations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

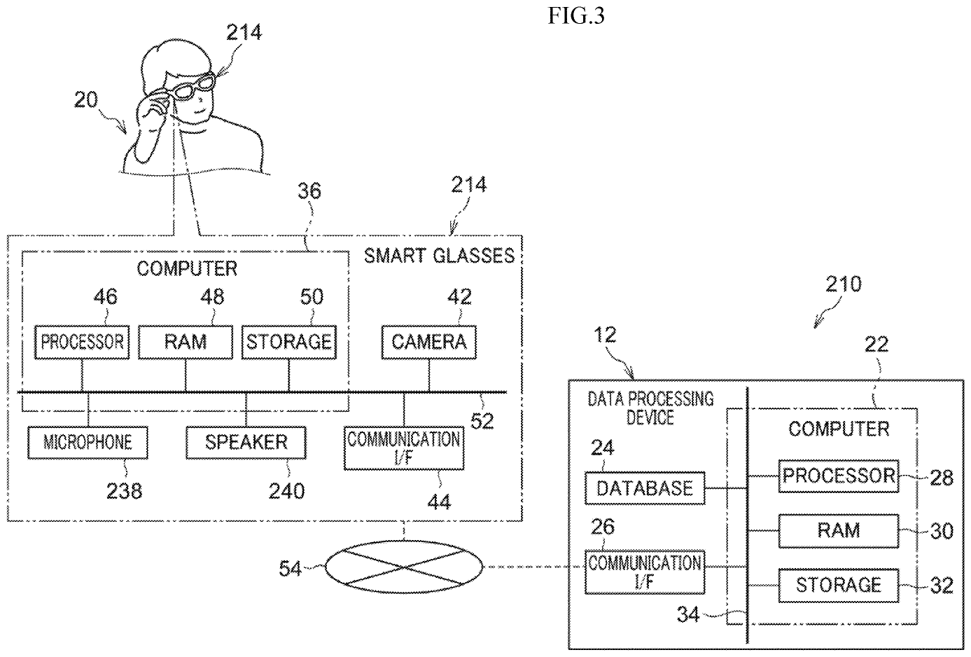

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

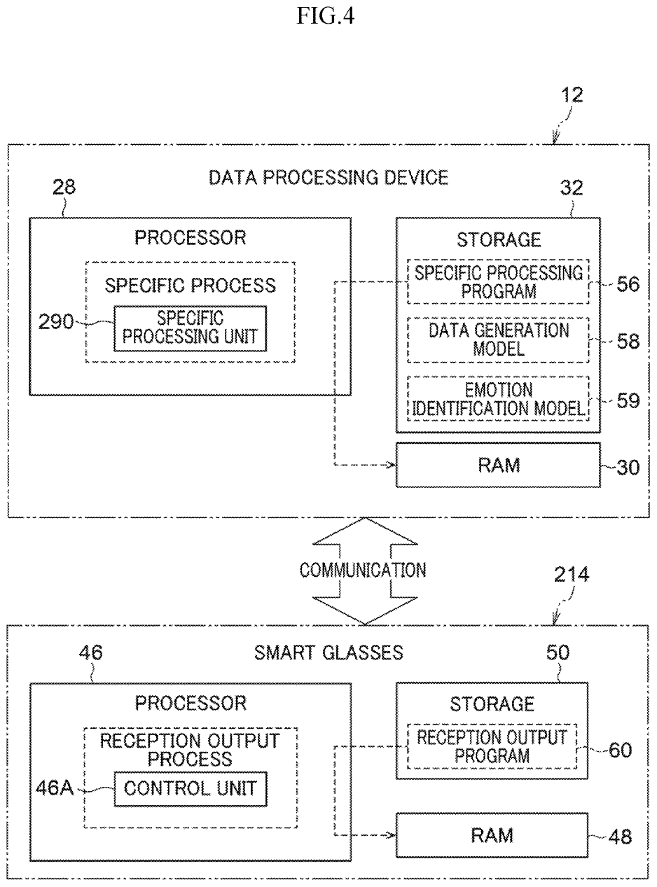

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

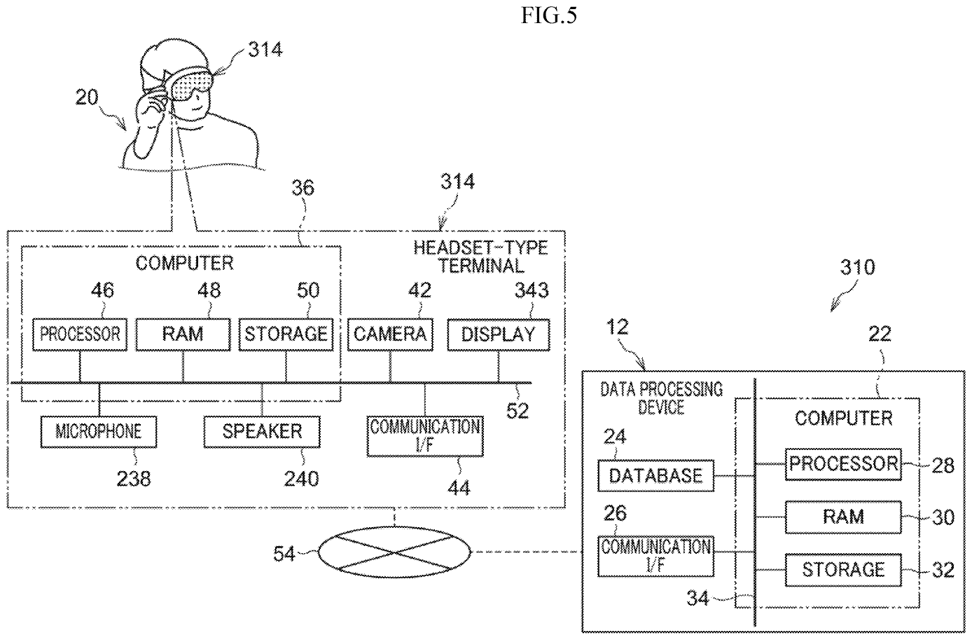

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

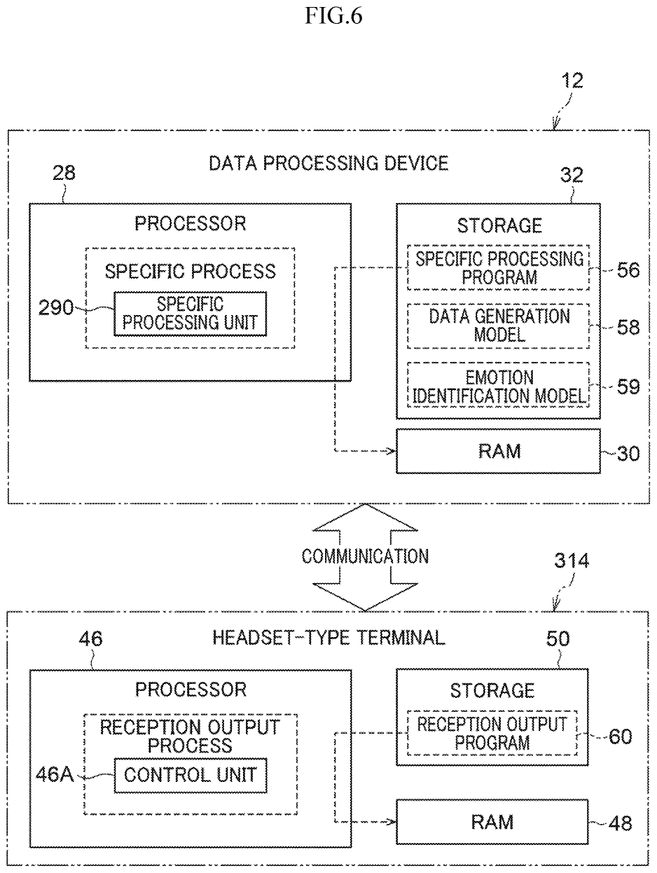

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

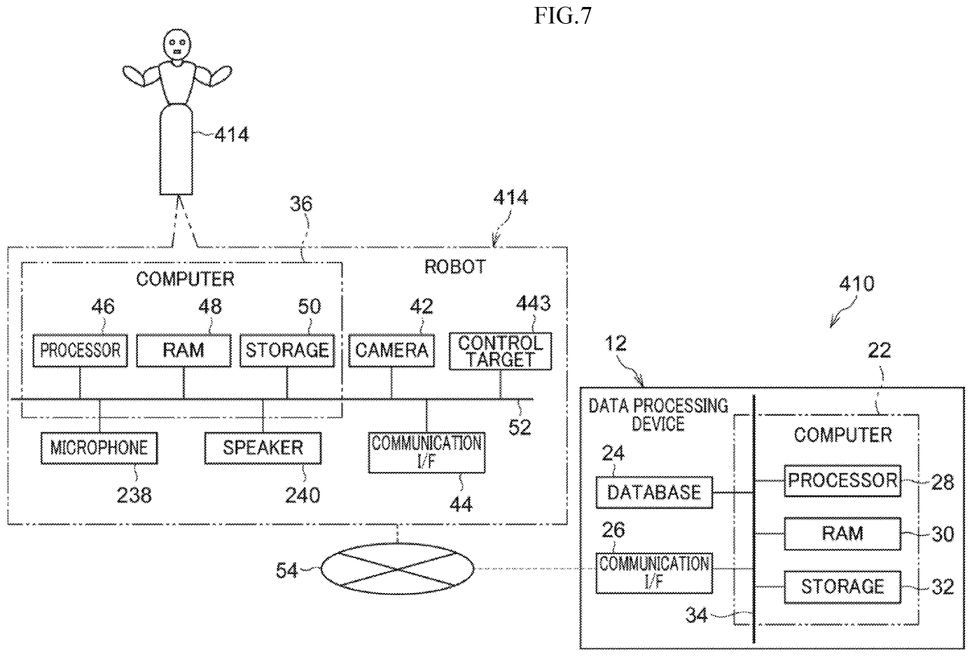

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

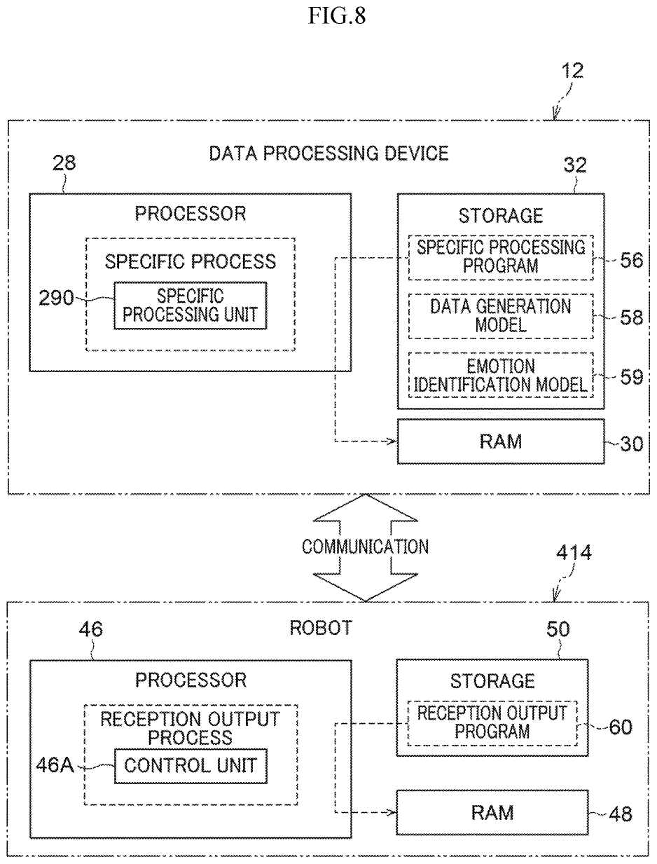

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

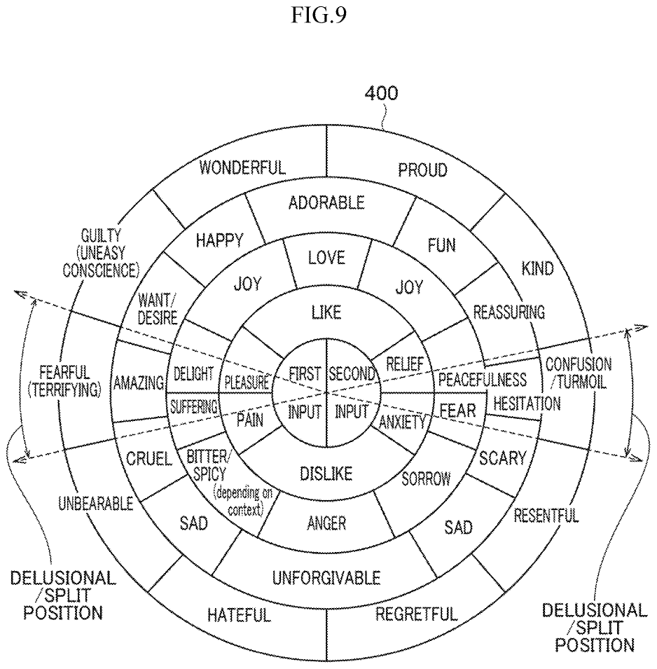

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

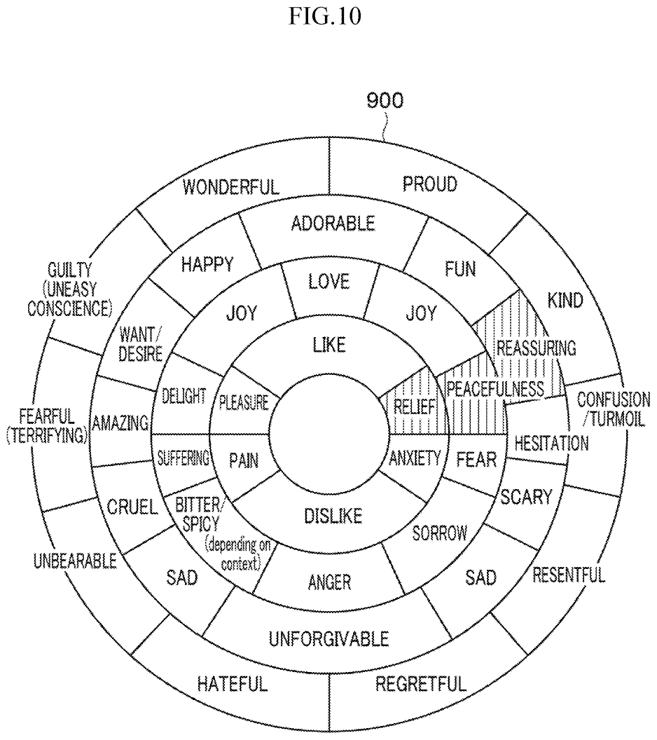

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire natural language text representing contents of a project, the natural language text being input by a user through a terminal, and perform preprocessing on the natural language text including morphological analysis, syntactic analysis, named entity extraction, and removal of unnecessary words, so as to extract keywords and phrases related to an objective of the project and required resources, and generate a prompt sentence that instructs execution of the preprocessing and extraction,
generate, on the basis of the extracted keywords and phrases and the natural language text, a feature vector representing semantic contents of the project by using a natural language processing model or a similarity calculation model that generates distributed representation vectors, and generate a prompt sentence that instructs identification of similar or related projects on the basis of the feature vector,
generate a prompt sentence that instructs a data storage device to execute word-based searching using the extracted keywords and vector-based searching using the feature vector, and to acquire past projects, related materials, and member information, and integrate word-based search results and vector-based search results to generate integrated search results ranked according to relevance,
estimate skills required for the project on the basis of the natural language text and the integrated search results, compare the estimated skills with skill information of members and past project participation histories of the members to specify candidate members, and generate a prompt sentence that instructs execution of the comparison and specification, generate, using structured data including the contents of the project, the similar or related projects, the related materials, and information of the candidate members as input, a prompt sentence that instructs a generative AI model to generate an explanatory text including a summary and recommendation reasons, acquire the explanatory text generated by the generative AI model in response to the prompt sentence, and control presentation of the explanatory text in association with the integrated search results to the user, and analyze emotion or urgency of the user on the basis of the input text of the user or an operation history of the user, and generate a prompt sentence that instructs adjustment of a presentation order of the integrated search results and the candidate members according to an analysis result.

### Supplementary 2

The system according to supplementary 1,
wherein the processor is configured to
execute, by using the generated prompt sentences, a workflow including project input, keyword extraction, feature vector generation, data storage device searching, member recommendation, and explanatory text generation by the generative AI model, in a sequential or parallel manner, and transmit execution results of the workflow to the terminal in a machine-readable format.

### Supplementary 3

The system according to supplementary 1,
wherein the processor is configured to
receive an additional prompt sentence input by the user, generate a re-evaluation prompt sentence that instructs the generative AI model to perform re-evaluation of relevance or re-selection of candidate members on the basis of the additional prompt sentence, the contents of the project, and the integrated search results, acquire a re-evaluation result from the generative AI model, and update and re-present search results and recommendation results to the terminal on the basis of the re-evaluation result.

### Application Example 1

### Supplementary 1

A system comprising a processor,
wherein the processor is configured to
acquire description information and required capability information relating to a project, perform character string normalization, tokenization, part-of-speech analysis, and important term extraction on the description information, and generate a prompt sentence for instructing a search of information based on contents of the project,
convert the description information and the important terms into semantic representation vectors by inputting the description information and the important terms to a machine learning model that generates distributed representation vectors, calculate similarity between the semantic representation vectors and semantic representation vectors associated with past work information, related material information, and member capability information stored in a storage device, and generate a prompt sentence for instructing identification of past work information and related material information that are similar or related on a basis of the similarity,
compare the required capability information relating to the project with the member capability information as semantic representation vectors or attribute vectors, select, as candidate members, members having capabilities required for the project, and generate a prompt sentence for instructing presentation of the candidate members as recommended members,
generate a prompt sentence for requesting a generative artificial intelligence model to generate a work plan proposal including work items, required capabilities, and reference materials for each phase of the project, on a basis of the past work information that is similar or related and the related material information, and
update progress state information representing a progress state of the project on a basis of the work plan proposal and the candidate members, and generate output information for transmitting the progress state information to a terminal device.

### Supplementary 2

The system according to supplementary 1,
wherein the processor is configured to
transmit, via a network, the output information including the progress state information to the terminal device periodically or in an event-driven manner, cause the terminal device to display, in real time, at least a progress state of on-site work, a next work item to be executed, and a reference material to be referred to, and update the progress state information on a basis of progress report information and feedback information transmitted from the terminal device.

### Supplementary 3

The system according to supplementary 1,
wherein the processor is configured to
integrate the work plan proposal, the candidate members, and the progress state information, automatically re-evaluate priorities of work items, members, and reference materials in the project on a basis of similarity information, history information, and output information from the generative artificial intelligence model, and generate and output dashboard information including a result of the re-evaluation.

### Example 2

### Supplementary 1

A system comprising a processor and a storage device,
wherein the processor is configured to
acquire description information related to a task that is input by a user via a terminal, analyze the description information by using a natural language processing technique to extract expression sequences, important expressions, and feature quantities from the description information, and convert the description information into structured information, generate a numerical vector based on the structured information, and calculate similarity between the numerical vector and a plurality of numerical vectors related to tasks stored in the storage device, thereby extracting task-related information that is similar or related to the description information,
generate a prompt sentence to be input to a generative information processing model based on the description information, the structured information, and the extracted task-related information, and instruct the generative information processing model to process the prompt sentence,
acquire result information output from the generative information processing model, and cause the terminal to present the result information in association with the extracted task-related information, and
estimate an emotional state of the user based on input information or operation information of the user, and adjust at least one of a display order and an emphasis degree of information presented on the terminal according to the emotional state.

### Supplementary 2

The system according to supplementary 1,
wherein the processor is configured to
generate a search request for an information set stored in the storage device based on the description information and the structured information, and search the information set by using a combination of the search request and the prompt sentence to be input to the generative information processing model, thereby acquiring information related to the description information.

### Supplementary 3

The system according to supplementary 1,
wherein the processor is configured to
generate a prompt sentence for comparing the feature quantities extracted from the description information with capability information of constituent elements, input the prompt sentence to the generative information processing model, select constituent elements having capabilities required for the task based on output of the generative information processing model, and cause the terminal to present recommendations of the constituent elements.

### Application Example 2

### Supplementary 1

A system comprising a processor,
wherein the processor is configured to
receive project-related description information and a prompt sentence from a user terminal and perform language information processing on the description information and the prompt sentence,
generate, on the basis of feature information extracted by the language information processing, a prompt sentence for issuing a search request to an information storage apparatus that stores past activity information and material information, and acquire similar or related activity information and material information in response to the search request, extract capability information required for a project from the description information, generate a prompt sentence for comparing the capability information with capability information associated with organizational units, and specify, on the basis of a comparison result, organizational units suitable for the project,
estimate an emotional state on the basis of user input including at least one of text information, audio information, and image information by using an emotion estimation function, and generate a prompt sentence for adjusting an order or importance of information provision on the basis of the emotional state and the acquired activity information, material information, and organizational-unit-related information, and assign priorities to the information in accordance with the adjustment,
generate an internal prompt sentence including the description information, the feature information, the emotional state, and the acquired information, input the internal prompt sentence to a generative information processing model, and cause the generative information processing model to generate response information including at least one of summary information regarding the project, recommended procedure information, recommended technology information, and recommended organizational-unit information, and integrate the response information and the prioritized information and generate display control information for output to the user terminal.

### Supplementary 2

The system according to supplementary 1,
wherein the processor is configured to
cause the language information processing to perform at least morphological analysis, phrase extraction, and similarity calculation, embed search conditions for searching the information storage apparatus into the prompt sentence on the basis of results of the language information processing, and execute processing of iteratively searching the information storage apparatus while successively updating the search conditions by using the response information obtained from the generative information processing model.

### Supplementary 3

The system according to supplementary 1,
wherein the processor is configured to
provide the emotional state estimated by the emotion estimation function as part of input to the generative information processing model, generate a prompt sentence that instructs the generative information processing model to generate the response information in a presentation style and presentation order corresponding to the emotional state, and perform control to dynamically change contents and priorities of information provision according to the emotional state of a user on the basis of the response information obtained from the generative information processing model.

What is claimed is:

1. A system comprising:
circuitry configured to:
receive, via a communication interface coupled to a packet-switched network, natural language text representing contents of a project from a terminal device, perform structured preprocessing including morphological analysis, syntactic analysis, named entity extraction, and removal of unnecessary words, and extract keywords and phrases related to an objective of the project;
generate a prompt sentence incorporating the extracted keywords, input the prompt sentence to a generative AI model to identify similar or related projects stored in a storage device, and obtain result information including summaries, similarity scores, and suggested features from the generative AI model; and
analyze a sentiment of the user based on data received from the terminal device via the communication interface, adjust the result information based on the analyzed sentiment, and transmit the adjusted result information to the terminal device via the communication interface.

2. The system according to claim 1, wherein the circuitry is configured to generate a first prompt sentence incorporating the extracted keywords and an instruction for the generative AI model to search for similar projects, and obtain from the generative AI model a list of similar project identifiers ranked by similarity score.

3. The system according to claim 2, wherein the circuitry is configured to retrieve metadata and summaries for the identified similar projects from the storage device, and generate a second prompt sentence incorporating the retrieved metadata to obtain from the generative AI model an analysis of key lessons learned and proposed innovative features.

4. The system according to claim 3, wherein the circuitry is configured to link the result information with the similar project identifiers and similarity scores in a presentation data structure, and transmit the presentation data structure to the terminal device via the communication interface.

5. The system according to claim 1, wherein the circuitry is configured to generate a third prompt sentence incorporating the extracted keywords and an instruction for the generative AI model to identify relevant information resources, obtain resource identifiers from the generative AI model, and retrieve corresponding information from the storage device.

6. The system according to claim 5, wherein the circuitry is configured to generate a relevance score for each retrieved information resource by comparing a vector representation of the resource with a vector representation of the project description, and filter resources below a relevance threshold.

7. The system according to claim 1, wherein the circuitry is configured to analyze the sentiment of the user by applying a sentiment analysis algorithm to text input received from the terminal device via the communication interface, and classify the sentiment into a plurality of categories.

8. The system according to claim 7, wherein the circuitry is configured to adjust at least one of a result presentation order, a content emphasis, and a feature suggestion tone of the result information based on the classified sentiment.

9. The system according to claim 1, wherein the circuitry is configured to receive, from the terminal device, a project description update via the communication interface, regenerate the extracted keywords based on the updated description, and generate an updated prompt sentence for the generative AI model.

10. The system according to claim 9, wherein the circuitry is configured to store the updated project description and the regenerated keywords in the storage device in association with a project identifier, and use the stored information for iterative refinement of similar project identification.

11. The system according to claim 1, wherein the circuitry is configured to generate a prompt sentence instructing the generative AI model to identify relevant human resources from a resource registry stored in the storage device based on the project keywords, and transmit resource recommendations to the terminal device.

12. The system according to claim 11, wherein the circuitry is configured to score the recommended human resources based on skill match scores computed from the project keywords and resource profiles stored in the storage device, and filter resources below a skill match threshold.

13. The system according to claim 1, wherein the circuitry is configured to pass the prompt sentence to a generative AI client module that formats the prompt sentence into a request for a generative AI model, the generative AI model using a transformer architecture to generate result information as a sequence of output tokens.

14. The system according to claim 13, wherein the circuitry is configured to decode the output tokens using a decoding strategy, obtain result information as a text string, and parse the text string to extract structured fields including summaries, suggestions, and feature proposals.

15. The system according to claim 1, wherein the circuitry is configured to store records of project descriptions, extracted keywords, similar projects identified, and result information in the storage device, and use the stored records to accelerate similar project identification for subsequent requests.

16. The system according to claim 15, wherein the circuitry is configured to apply indexing to the stored project descriptions in the storage device to enable efficient retrieval, and use the index when searching for similar projects in response to new project descriptions.

17. The system according to claim 1, wherein the circuitry is configured to receive feedback from the terminal device indicating whether the similar projects and suggestions were useful, incorporate the feedback into the storage device, and adjust relevance scoring parameters based on the feedback.

18. A system comprising:
circuitry configured to:
receive, via a communication interface coupled to a packet-switched network, natural language text representing contents of a project from a terminal device, perform structured preprocessing to extract keywords and phrases, and store the keywords in a storage device;
generate a prompt sentence incorporating the extracted keywords, input the prompt sentence to a generative AI model, and obtain result information including similar project identifiers and innovative feature suggestions ranked by similarity scores;
analyze a sentiment of the user based on data received from the terminal device via the communication interface, and adjust the result information based on the analyzed sentiment; and
transmit the adjusted result information to the terminal device via the communication interface, and update the storage device based on feedback received from the terminal device.

19. The system according to claim 18, wherein the circuitry is configured to generate a second prompt sentence incorporating metadata of identified similar projects, input the second prompt sentence to the generative AI model, and obtain from the generative AI model an analysis of lessons learned and proposed differentiating features for transmission to the terminal device.

20. A method comprising:
receiving, via a communication interface coupled to a packet-switched network, natural language text representing contents of a project from a terminal device, performing structured preprocessing including morphological analysis, named entity extraction, and removal of unnecessary words, and extracting keywords and phrases related to an objective of the project;
generating a prompt sentence incorporating the extracted keywords, inputting the prompt sentence to a generative AI model to identify similar or related projects, and obtaining result information from the generative AI model; and
analyzing a sentiment of the user based on data received from the terminal device via the communication interface, adjusting the result information based on the analyzed sentiment, and transmitting the adjusted result information to the terminal device via the communication interface.
